(19) United States
(12) Patent Application Publication
(10) Pub. No.: US 2020/0074839 A1
(43) Pub. Date: Mar. 5, 2020

(54) SITUATIONAL AWARENESS PLATFORM, METHODS, AND DEVICES

(71) Applicant: Frank Trigg, Hartford, CT (US)

(72) Inventor: Frank Trigg, Hartford, CT (US)

(21) Appl. No.: 16/539,443

(22) Filed: Aug. 13, 2019

Related U.S. Application Data
(63) Continuation of application No. 16/033,864, filed on Jul. 12, 2018, now abandoned.

(51) Int. Cl. G08B 25/01; G08B 25/00; G06N 20/00; G06F 16/43; G06F 9/54

(52) U.S. Cl. CPC G08B 25/016; G08B 25/006; G06F 9/542; G06F 16/43; G06N 20/00

(57) ABSTRACT

Methods and systems for a personal security platform. In one aspect, a method includes connecting to a user device and receiving user data; receiving and querying saved guardian network data; receiving, querying, and storing guardian sets from the user device; querying and receiving at least one stream from at least one capture device to yield at least one capture data stream; optimizing the at least one capture data stream for transmission to the personal security platform; and upon receiving at least one trigger condition, sending an alert to the saved guardian sets.

### CROSS-REFERENCE TO RELATED APPLICATIONS

This patent application is a Continuation of and claims the benefit of similarly-titled U.S. patent application Ser. No. 16/033,864, filed Jul. 12, 2018, the entire disclosure of each of which is incorporated herein by reference.

### TECHNICAL FIELD

This novel technology relates to the field of security systems. More specifically, the present technology is in the technical field of optimized, interconnected personal security systems.

### BACKGROUND

Unfortunately, in today's society, personal safety and security from external threats has become a major focal point. This is primarily due to a rise in organized criminal activities, global threats against society, and increased desperation due to addiction and the like. In response, some individuals resort to carrying a weapon, such as a firearm or knife, which itself may pose more problems than the weapon solves. For example, firearms may be stolen, misplaced, or accidentally discharge, and displaying a weapon in certain areas could potentially escalate a situation already fraught danger and invoke a lethal response. Thus, many opt for a less-than-lethal alternative, such as pepper spray, self-defense training, but these options still fail to provide overall security against persistent threats or where the victim is overpowered.

Further, many attackers and suspects get away with their crimes because the victim simply cannot recall enough accurate details of the attack and attacker. While many law enforcement officials advise trying to notice and recall unique identifying characteristics of the attacker, many victims simply cannot try to decipher a faded tattoo while simultaneously protecting themselves. This creates a delicate balance between security for the individual and retaining enough identifying information to allow the authorities to catch and punish assailants.

Thus, what is needed is a more efficient and consistent method to deal with threats that are preventable and also to give law enforcement the best chance of identifying and resolve threats that unfortunately were not prevented.

The present novel technology addresses these needs.

### BRIEF DESCRIPTION OF THE DRAWINGS

FIG. 1 is a block diagram of an example environment in which the Situational Awareness Platform may exist.

FIG. 2 is a system diagram of an example computer system that may be used to operate the Situational Awareness Platform.

FIG. 3 is a block diagram of an example wearable device used with Situational Awareness Platform.

FIG. 4 depicts a first screenshot associated with the User Account on the Situational Awareness Platform.

FIG. 5A depicts a second screenshot associated with My Users on the Situational Awareness Platform.

FIG. 5B depicts a third screenshot associated with My Guardians on the Situational Awareness Platform.

FIG. 6A depicts a fourth screenshot associated with Group Users on the Situational Awareness Platform.

FIG. 6B depicts a fifth screenshot associated with Group Users on the Situational Awareness Platform.

FIG. 7 depicts a sixth screenshot associated with Notifications on the Situational Awareness Platform.

FIG. 8A depicts a seventh screenshot associated with Triggered Alerts on the Situational Awareness Platform.

FIG. 8B depicts an eighth screenshot associated with Incoming Alerts on the Situational Awareness Platform.

FIG. 8C depicts a ninth screenshot associated with Alarming Alerts on the Situational Awareness Platform.

FIG. 8D depicts a tenth screenshot associated with Map Alerts on the Situational Awareness Platform.

FIG. 8E depicts an eleventh screenshot associated with Resolved Alerts on the Situational Awareness Platform.

FIG. 9A depicts a first process flow chart associated with an implementation for the Situational Awareness Platform.

FIG. 9B depicts a continuation of the first process flow chart associated with an implementation for the Situational Awareness Platform.

FIG. 10A depicts a second process flow chart associated with an implementation for the Situational Awareness Platform.

FIG. 10B depicts a continuation of the second process flow chart associated with an implementation for the Situational Awareness Platform.

Like reference numbers and designations in the various drawings indicate like elements.

The details of one or more embodiments of the subject matter described in this specification are set forth in the accompanying drawings and the description below. Other features, aspects, and advantages of the subject matter will become apparent from the description, the drawings, and the claims.

### DETAILED DESCRIPTION

Before the present methods, implementations, and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often though may not occur, and that the description includes instances where said event or circumstance occurs and instances where it does not. Additionally, “generates,” “populates,” “generating,” and “populating” mean that the system, client, end user (user, system user), and/or module may produce some event or cause some event element to be produced.

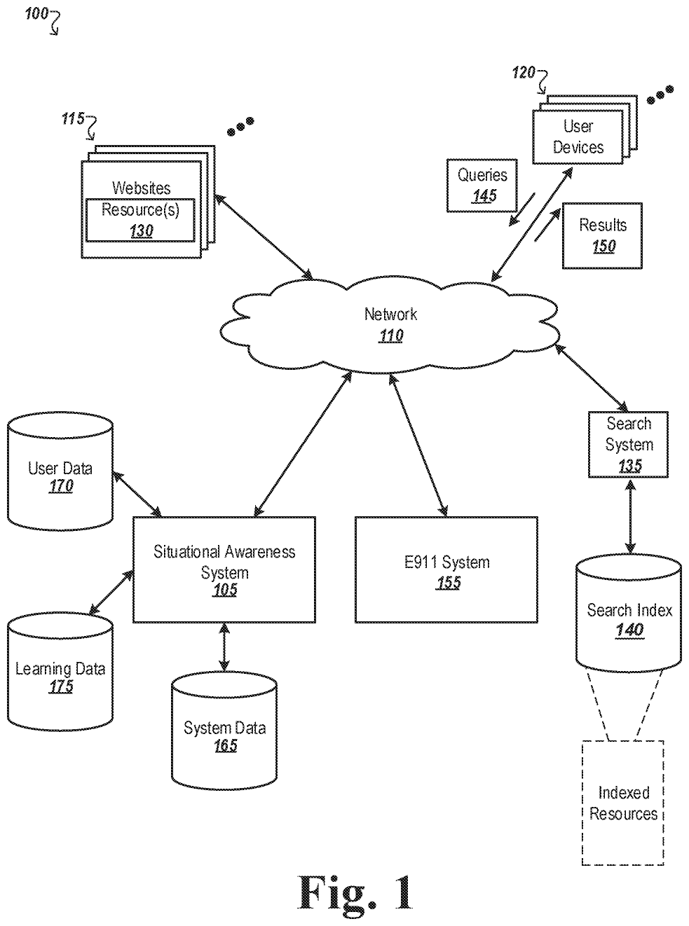

FIGS. 1-10B depict various aspects of the present novel technology. FIG. 1 is a block diagram of an example environment 100 in which situational awareness platform 105 may exist. Environment 100 may typically include situational awareness platform 105; network 110; website(s) 115; end user device(s) 120; resource(s) 130; search system 135; search index 140; queries 145; result(s) 150; E911 system 155; system datastore(s) 165; user datastore(s); and/or learning datastore(s). Situational awareness platform 105 may facilitate creation and operation of an interconnected personal security system according to the present disclosure. Example environment 100 also includes network 110, such as a local area network (LAN), a wide area network (WAN), the Internet, or a combination thereof. Network 110 may connect websites 115, end user device(s) 120, and/or situational awareness platform 105. Example environment 100 may potentially include many thousands of website(s) 115 and/or end user device(s) 120.

Website(s) 115 may be one or more resources 130 associated with a domain name and hosted by one or more servers. An example website(s) 115 may be a collection of webpages formatted in hypertext markup language (HTML) that may contain text, images, multimedia content, and programming elements, such as scripts. Each website(s) 115 may be maintained by a publisher, which may be an entity that controls, manages, and/or owns each website(s) 115. Example websites 115 may, for example, be pages for viewing platform 105 videos, social media websites, public safety websites, map data websites, and/or the like.

Resource(s) 130 may be any data that may be provided over the network 110. A resource(s) 130 may be identified by a resource address (e.g., a URL) that may be associated with the resource(s) 130. Resources 130 include HTML webpages, word processing documents, and portable document format (PDF) documents, images, video, and feed sources, to name only a few. Resources 130 may include content, such as words, phrases, images and sounds, that may include embedded information—such as meta-information in hyperlinks—and/or embedded instructions, such as JAVASCRIPT scripts (JAVASCRIPT is a registered trademark of Sun Microsystems, Inc., a Delaware corporation, located at 4150 Network Circle Santa Clara, Calif. 95054). Units of content—for example, data files, scripts, content files, or other digital data—that may be presented in (or with) resources may be referred to as content items.

Some example resources may, for example, be social media posts, social media trends, public safety announcements, geolocation databases, map databases, geolocation image clearinghouse databases, cellular coverage maps, audiovideo device databases, and/or the like. For example platform 105 may aggregate trending public safety announcement information from social media to issue an alert to platform 105 users, compare received photographic data to known geolocations for location identification using an image clearinghouse, and/or the like

End user devices 120 may be electronic devices that may be under the control of an end user and may be capable of requesting and receiving resources 130 over network 110. Example end user devices 120 include personal computers, mobile communication devices, and other devices that may send and receive data over the network 110. End user devices 120 typically include a user application, such as a web browser, to facilitate the sending and receiving of data over the network 110. End user devices 120 may also include wearables (e.g., wearable 300, discussed below), that a platform 105 user may have on his or her person to send and receive data with platform 105.

In some implementations, websites 115 (apps, client services; hereinafter simply “websites” for ease of use), end user devices 120, and system 105 may directly intercommunicate, excluding the need for the Internet from the scope of a network 110. For example, the websites 115, end user devices 120, and the situational awareness platform 105 may directly communicate over device-to-device (D2D) communication protocols (e.g., WI-FI DIRECT (WI-FI DIRECT is a registered trademark of Wi-Fi Alliance, a California corporation, located at 10900-B Stonelake Boulevard, Suite 126, Austin, Tex. 78759); Long Term Evolution (LTE) D2D (LTE is a registered trademark of Institut Europeen des Normes; a French nonprofit telecommunication association, located at 650 route des Lucioles, F-06921, Sophia Antipolis, France), LTE Advanced (LTE-A) D2D, etc.), wireless wide area networks, and/or satellite links thus eliminate the need for the network 110 entirely. In other implementations, the websites 115, end user devices 120, and system 105 may communicate indirectly to the exclusion of the Internet from the scope of the network 110 by communicating over wireless wide area networks and/or satellite links. Further, end user devices 120 may similarly send and receive search queries 145 and search results 150 indirectly or directly.

In wireless wide area networks, communication primarily occurs through the transmission of radio signals over analog, digital cellular, or personal communications service (PCS) networks. Signals may also be transmitted through microwaves and other electromagnetic waves. At the present time, most wireless data communication takes place across cellular systems using second generation technology such as code-division multiple access (CDMA), time division multiple access (TDMA), the Global System for Mobile Communications (GSM) (GSM is a registered trademark of GSM MoU Association, a Swiss association, located at Third Floor Block 2, Deansgrande Business Park, Deansgrande, Co Dublin, Ireland), Third Generation (wideband or 3G), Fourth Generation (broadband or 4G), personal digital cellular (PDC), or through packet-data technology over analog systems such as cellular digital packet data (CDPD) used on the Advance Mobile Phone System (AMPS).

The terms “wireless application protocol” and/or “WAP” mean a universal specification to facilitate the delivery and presentation of web-based data on handheld and mobile devices with small user interfaces. “Mobile Software” refers to the software operating system that allows for application programs to be implemented on a mobile device such as a mobile telephone or PDA. Examples of Mobile Software are JAVA and JAVA ME (JAVA and JAVA ME are trademarks of Sun Microsystems, Inc. of Santa Clara, Calif.), BREW (BREW is a registered trademark of Qualcomm Incorporated of San Diego, Calif.), WINDOWS Mobile (WINDOWS is a registered trademark of Microsoft Corporation of Redmond, Wash.), PALM OS (PALM is a registered trademark of Palm, Inc. of Sunnyvale, Calif.), SYMBIAN OS (SYMBIAN is a registered trademark of Symbian Software Limited Corporation of London, United Kingdom), ANDROID OS (ANDROID is a registered trademark of Google, Inc. of Mountain View, Calif.), and IPHONE OS (IPHONE is a registered trademark of Apple, Inc. of Cupertino, Calif.), and WINDOWS PHONE 7 (WINDOWS PHONE is a registered trademark the Microsoft Corporation of Redmond, Wash.). “Mobile Apps” refers to software programs written for execution with Mobile Software.

The situational awareness platform 105 may use one or more modules to perform various functions including, but not limited to, searching, analyzing, querying, interfacing, etc. A “module” refers to a portion of a computer system and/or software program that carries out one or more specific functions and may be used alone or combined with other modules of the same system or program. For example, a module may be located on the situational awareness platform 105 (e.g., on the servers of system 105, i.e., server-side module), on end user devices 120, or on an intermediary device (e.g., the client server, i.e., a client-side module; another end user device(s) 120; a different server on the network 110; or any other machine capable of direct or indirect communication with system 105, websites 115, the search system 135, and/or the end user devices 120.)

In some implementations, the system 105 may be performed through a system 105 module. For example, a user may install a program to interface with a system 105 server to communicate data, interactions, audiovisual streams, safety data, and/or the like to the user's end user device(s) 120. In some other implementations, the system 105 may be installed on a user's machine and operate—in whole or in part—independently of system 105 WAN and/or LAN components. For example, the system 105 software may be deployed to a user's computer as a standalone program that interfaces with the user's computer, creates and maintains data store(s), send and receive user/guardian information, send/receive audiovisual data, send/receive alters, etc. In another example, the system 105 may interact with and/or be installed as an Internet browser extension. For example, the system 105 may be a program installed as an extension, add-on, and/or plugin of GOOGLE CHROME (GOOGLE CHROME is a registered trademark of Google, Inc., a Delaware corporation, located at 1600 Amphitheatre Parkway, Mountain View, Calif. 94043); MOZILLA FIREFOX (MOZILLA and FIREFOX are registered trademarks of the Mozilla Foundation, a California non-profit corporation, located at 313 East Evelyn Avenue, Mountain View, Calif. 94041); APPLE SAFARI (APPLE and SAFARI are registered trademarks of Apple, Inc., a California corporation, located at 1 Infinite Loop, Cupertino, Calif. 95014), etc. The browser extension may, for example, receive user platform 105 credentials, query user platform 105 data, send and receive audiovisual data, send and receive guardian data, and/or the like.

In some implementations, navigation through a platform 105 and/or associated features may be accomplished through a user's input of commands. For example, a user may vocally command the system 105 play an alert, replay an alert, trigger an alert, take a picture, forward an alert to the police, and/or the like. In another example, a user may input commands on an input device (e.g., a keyboard, touchpad, wearable button, etc.) to command the system 105 (e.g., long-press wearable SOS button to trigger alert and take video, triple press power button to trigger silent alert, press Forward Alert button 828 to send received alert to another user, etc.).

Typically, modules may be coded in JAVASCRIPT, PYTHON, PHP, or HTML, but may be created using any known programming language (e.g., BASIC, FORTRAN, C, C++, C#, PERL (PERL is a registered trademark of Yet Another Society DBA The Perl Foundation, a Michigan nonprofit corporation, located at 340 S. Lemon Ave. #6055, Walnut, Calif. 91789), etc.) and/or package (e.g., compressed file (e.g., zip, gzip, 7zip, RAR (RAR is a registered trademark of Alexander Roshal, an individual, located in the Russian Federation AlgoComp Ltd., Kosareva 52b-83, Chelyabinsk, Russian Federation 454106), etc.), executable, etc.).

In some implementations, the situational awareness platform 105 may be packaged, distributed, scripted, installed by a technician of system 105, and/or otherwise deployed to a client server location such that system 105 exists within the client server and/or client server network, either in whole or in part. For example, the situational awareness platform 105 may be scripted and/or packaged into an executable package and downloaded by a client administrator; the client administrator then installing system 105 software package(s) onto the client server(s). Such setups may allow the situational awareness platform 105 to operate all system 105 operations entirely within the client server(s) and/or client network, excluding the need to interface with system 105 provider's servers for some or all system 105 functions. Such an implementation may, for example, be used to reduce bandwidth, latency, complexity of network management, etc. In some other implementations, the client servers may facilitate only some of system 105 functions and interface with system 105 servers (over a network or directly) to enable those remaining functions. Still other implementations may link to system 105 servers to obtain updates, patches, and/or other modifications to system 105 distributions.

Situational awareness platform 105 software distributions may, in some implementations, be installed in a virtual environment (e.g., HYPER-V (HYPER-V is a registered trademark of Microsoft, a Washington Corporation, located at One Microsoft Way, Redmond, Wash. 98052); VIRTUALBOX (VIRTUALBOX is a registered trademark of Oracle America, Inc., a Delaware corporation, located at 500 Oracle Parkway, Redwood Shores, Calif. 94065); VMWARE (VMWARE is a registered trademark of VMWare, Inc., a Delaware corporation, located at 3401 Hillview Ave., Palo Alto, Calif. 94304), etc.).

In other implementations, situational awareness platform 105 software may be installed in whole or in part on an intermediary system that may be separate from the client and system 105 servers. For example, situational awareness platform 105 software may be installed by an intermediary worker, a client worker, and/or a system 105 worker onto a hosting service (e.g., AMAZON WEB SERVICES (AWS) (AWS is a registered trademark of Amazon Technologies, Inc., a Nevada corporation, located at PO Box 8102, Reno, Nev. 89507), RACKSPACE (RACKSPACE is a registered trademark of Rackspace US, Inc., a Delaware corporation, located at 1 Fanatical Place, City of Windcrest, San Antonio, Tex. 78218), etc. The client may then connect to the intermediary and/or system 105 servers to access system 105 functions. Such implementations may, for example, allow distributed access, redundancy, decreased latency, etc.

End user device(s) 120 may request resources 130 from website(s) 115. In turn, data representing resource(s) 130 may be provided to end user device(s) 120 for presentation by end user device(s) 120. Data representing resource(s) 130 may also include data specifying a portion of the resource(s) 130 or a portion of a user display—for example, a small search text box or a presentation location of a pop-up window—in which trends, advertisements, third-party search tools, etc. may be presented.

To facilitate searching of resource(s) 130, environment 100 and/or system 105 may include a search system 135 that identifies resource(s) 130 by crawling and indexing resource(s) 130 provided by publishers on website(s) 115. Data about resource(s) 130 may be indexed based on resource(s) 130 to which the data corresponds. The indexed and, optionally, cached copies of resource(s) 130 may be stored in, for example, search index 140. For example, search system 135 may monitor and pull data resources 130 from social networks to provide live updates and notices to platform 105 users, or to interface with known-good picture clearinghouses for geolocation identification.

End user device(s) 120 may submit search queries 145 to search system 135 over network 110. In response, search system 135 accesses search index 140 to identify resource(s) 130 that may be relevant to search query 145. Search system 135 identifies the resources 130 in the form of result(s) 150 and returns the result(s) 150 to end user devices 120 in search results webpages. Search result(s) 150 may be data generated by the search system 135 that identifies a resource(s) 130 that may be responsive to a particular search query and/or includes a link to the resource(s) 130. An example search result(s) 150 may include a webpage title, a snippet of text or a portion of an image extracted from the webpage, a geolocation trend, a security alert, the URL of the webpage, and/or like.

Users and/or end user devices 120 that may be interested in a particular subject may perform a search by submitting one or more queries 145 to search system 135 in an effort to identify related information. For example, a user that may be interested may submit queries 145 such as “majors news near me,” “accident near fourth and main street,” or “sirens downtown Atlanta.” In response to each of these queries 145, the user may be provided search result(s) 150 that have been identified as responsive to the search query—that is, have at least a minimum threshold relevance to the search query, for example, based on cosine similarity measures, clustering techniques, machine learning techniques, and/or the like. The user may then select one or more of the search result(s) 150 to request presentation of a webpage other resource(s) 130, and/or alerts on platform 105, that may be referenced by a URL associated with the search result(s) 150.

Other implementations of the situational awareness platform 105 may allow for a game-like components, or gamification, aspect to interaction with system 105. For example, tangible (e.g., money, goods, etc.) and/or intangible (e.g., account badges, cryptocurrency, user name flair, etc.) rewards may be given to users who submit public awareness audiovisual data to system 105, users voted most active on system 105, etc.

When search result(s) 150 are requested by an end user device(s) 120, the situational awareness platform 105 may receive a request for data to be provided with the resource(s) 130 or search results 150. In response to the request, the situational awareness platform 105 selects data that are determined to be relevant to the search query. In turn, the selected data are provided to the end user device(s) 120 for presentation with the search results 150.

For example, in response to the search query “bomb near me,” system 105 may present the user with relevant social media trend data and/or public safety awareness-related results. If the user selects—for example, by clicking, touching, or otherwise indicating—search result(s) 150, the end user device(s) 120 may be redirected, for example, to a webpage containing compiled social media posts and pictures, news reports, and/or public safety advisories. This webpage may include, for example, where to go for shelter, police safety points, mechanisms to report your location and status to guardian network or relatives, etc.

The environment 100 may also include a system database(s) 165, user database(s) 170, and/or learning database(s) 175 to receive and record information regarding the situational awareness platform 105, website(s) 115, end user devices 120, and/or any other data useful to environment 100. For example, information regarding end user devices 120 and user identifiers may be stored and analyzed to determine user activity on system 105, social media trend accuracies, response rate of users based on alert triggers, and/or the like.

In some implementations, data that may be stored in the database(s) 165, 170, 175 may be anonymized to protect the identity of the user with which the user data may be associated. For example, user identifiers may be removed from the user data to provide to third-party clients. Alternatively, the user data may be associated with a hash value of the user identifier to anonymize the user identifier. In some implementations, data are only stored for users that opt-in to having their data stored. For example, a user may be provided an opt-in/opt-out user interface that allows the user to specify whether they approve storage of data associated with the user.

While system 105 may operate with only one of each component (e.g., one system 105, one website 115, one end user, one end user device 120, etc.), system 105 may be benefitted by multiple of these components (and/or in some instances greatly benefitted by a mass amount of said components). For example, the existence and activity of a plurality of users on system 105 may foster greater crowdsourcing of public safety alert information, social awareness, audiovisual data for review by authorities, and creativity and flexibility of feedback to system 105 for optimization and machine learning to best optimize system 105. Additionally, features such as game-like interaction of system 105 may be difficult or impossible without at least a small plurality of active users on system 105; however, as the number of active users increases, the likelihood of a successful ecosystem for the game-like system 105 features also increases and may tend to lead to greater success of system 105 and user activity (quantity and quality) compared to a small user base.

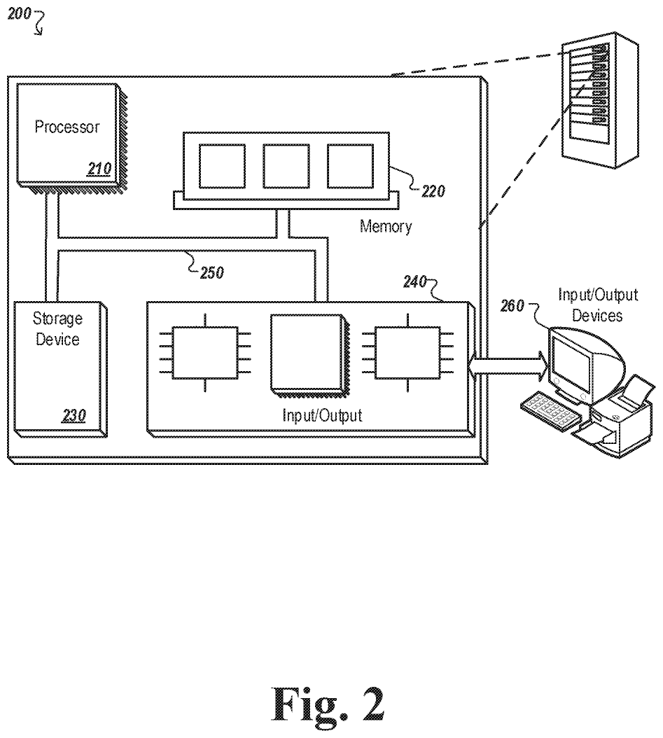

FIG. 2 is a block diagram of an example computer system 200 that may be used to provide situational awareness platform 105, as described above. The system 200 may typically include processor(s) 210; memory 220; storage device(s) 230; system input(s)/output(s) 240; system bus(es) 250; and input/output device(s) 260. Each of the components 210, 220, 230, and 240 typically may be interconnected, for example, using system bus(es) 250. Processor(s) 210 may be capable of processing instructions for execution within the system 200. In one implementation, processor(s) 210 may be a single-threaded processor. In another implementation, processor(s) 210 may be a multi-threaded processor. In yet another implementation, processor(s) 210 may be a single-core processor, a multiple-core processor, and/or multiple processors (i.e., more than one socketed processor). Processor(s) 210 typically may be capable of processing instructions stored in the memory 220 and/or on the storage device(s) 230.

Memory 220 stores information within system 200. In one implementation, memory 220 may be a computer-readable medium. In one other implementation, memory 220 may be a volatile memory unit. In another implementation, memory 220 may be a nonvolatile memory unit.

Storage device(s) 230 may be capable of providing mass storage for the system 200. In one implementation, storage device(s) 230 may be a computer-readable medium. In various different implementations, storage device(s) 230 may include, for example, a hard disk device, a solid-state disk device, an optical disk device, and/or some other large capacity storage device.

System input(s)/output(s) 240 provide input/output operations for the system 200. In one implementation, system input(s)/output(s) 240 may include one or more of a network interface devices, for example an Ethernet card; a serial communication device, for example an RS-232 port; and/or a wireless interface device, for example an IEEE 802.11 card. In another implementation, system input(s)/output(s) 240 may include driver devices configured to receive input data and send output data to other input/output device(s) 260, for example keyboards, printers, display devices, and/or any other input/output device(s) 260. Other implementations, however, may also be used, such as mobile computing devices, mobile communication devices, set-top box television client devices, etc.

Although an example processing system has been described in FIGS. 1 and 2, implementations of the subject matter and the functional operations described in this specification may be implemented in other types of digital electronic circuitry, or in computer software, firmware, or hardware, including the structures disclosed in this specification and their structural equivalents, or in combinations of one or more of them.

Embodiments of the subject matter and the operations described in this specification may be implemented as a method, in digital electronic circuitry, or in computer software, firmware, or hardware, including the structures disclosed in this specification and their structural equivalents, or in combinations of one or more of them. Embodiments of the subject matter described in this specification may be implemented as one or more computer programs—that is, one or more modules of computer program instructions encoded on computer storage medium for execution by, or to control the operation of, data processing apparatus. Alternatively or in addition, the program instructions may be encoded on an artificially-generated propagated signal, for example a machine-generated electrical, optical, or electromagnetic signal, which may be generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium may not be a propagated signal, a computer storage medium may be a source or destination of computer program instructions encoded in an artificially-generated propagated signal. The computer storage medium may also be, or be included in, one or more separate physical components or media (e.g., multiple CDs, disks, or other storage devices).

The operations described in this specification may be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus may include special purpose logic circuitry, for example an field programmable gate array (FPGA) or an application-specific integrated circuit (ASIC). The apparatus may also include, in addition to hardware, code that creates an execution environment for the computer program in question, for example code that constitutes processor firmware, a protocol stack, a database management system, an operating system, a cross-platform runtime environment, a virtual machine, or a combination of one or more of them. The apparatus and execution environment may realize various different computing model infrastructures, such as web services, distributed computing, and grid computing infrastructures.

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program can, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry, for example an FPGA or an ASIC.

Processors suitable for the execution of a computer program include, by way of example, both general and special purpose microprocessors, and any one or more processors of any kind of digital computer. Typically, a processor may receive instructions and data from a read-only memory or a random access memory or both. The essential elements of a computer are a processor for performing actions in accordance with instructions and one or more memory devices for storing instructions and data. Typically, a computer may also include, or be operatively coupled to receive data from or transfer data to, or both, one or more mass storage devices for storing data, e.g., magnetic, magneto-optical disks, or optical disks. However, a computer need not have such devices. Moreover, a computer may be embedded in another device, for example a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, for example erasable programmable read-only memory (EPROM), electrically erasable programmable read-only memory (EEPROM), and/or flash memory devices; magnetic disks, for example internal hard disks or removable disks; magneto-optical disks; and/or compact disk read-only memory (CD-ROM) and digital video disk real-only memory (DVD-ROM) disks. The processor and the memory may be supplemented by, or incorporated in, special purpose logic circuitry.

To provide for interaction with a user, embodiments of the subject matter described in this specification may be implemented on a computer having a display device (e.g., a cathode ray tube (CRT), liquid crystal display (LCD), or organic light-emitting diode (OLED) monitor), for displaying information to the user and a keyboard and a pointing device, e.g., a mouse, touchscreen, trackball, by which the user may provide input to the computer. These may, for example, be desktop computers, laptop computers, smart TVs, etc.

Other mechanisms of input may include portable and or console entertainment systems such as GAME BOY and/or NINTENDO DS ((GAME BOY, GAME BOY COLOR, GAME BOY ADVANCE, NINTENDO DS, NINTENDO 2DS, and NINTENDO 3DS are registered trademarks of Nintendo of America Inc., a Washington corporation, located at 4600 150th Avenue NE, Redmond, Wash. 98052), IPOD (IPOD is a registered trademark of Apple Inc., a California corporation, located at 1 Infinite Loop, Cupertino, Calif. 95014), XBOX (e.g., XBOX, XBOX ONE) (XBOX and XBOX ONE are a registered trademarks of Microsoft, a Washington corporation, located at One Microsoft Way, Redmond, Wash. 98052), PLAYSTATION (e.g., PLAYSTATION, PLAYSTATION 2, PS3, PS4, PLAYSTATION VITA) (PLAYSTATION, PLAYSTATION 2, PS3, PS4, and PLAYSTATION VITA are registered trademarks of Kabushiki Kaisha Sony Computer Entertainment TA, Sony Computer Entertainment Inc., a Japanese corporation, located at 1-7-1 Konan Minato-ku, Tokyo, 108-0075, Japan), WII (e.g., WII, WII U) (WII and WII U are registered trademarks of Nintendo of America Inc., a Washington corporation, located at 4600 150th Avenue NE, Redmond, Wash. 98052), etc.

Still other devices may include “smart home” or “personal assistant” devices, which may typically provide interactive voice command, recognition, and playback capabilities to a user, such a GOOGLE HOME (GOOGLE HOME is a registered trademark of Google LLC, a Delaware limited liability company, located at 1600 Amphitheatre Parkway, Mountain View, Calif. 94043), GOOGLE HOME MINI (GOOGLE HOME MINI is a registered trademark of Google LLC, a Delaware limited liability company, located at 1600 Amphitheatre Parkway, Mountain View, Calif. 94043), AMAZON ALEXA (ALEXA is a registered trademark of Amazon Technologies, Inc., a Nevada corporation, located at 410 Terry Ave N, Seattle, Wash. 98109), and/or the like.

Other kinds of devices may be used to provide for interaction with a user as well; for example, feedback provided to the user may be any form of sensory feedback, for example visual feedback, auditory feedback, or tactile feedback; and input from the user may be received in any form, including acoustic, speech, or tactile input. In addition, a computer may interact with a user by sending documents to and receiving documents from a device that may be used by the user; for example, by sending urgent news updates in audio and/or visual form to an end user device 120, wearable 300, and/or the like.

Some embodiments of the subject matter described in this specification may be implemented in a computing system 200 that includes a back-end component (e.g., a data server,) or that includes a middleware component (e.g., an application server,) or that includes a front-end component (e.g., a client computer having a graphical user interface or a Web browser through which a user may interact with an implementation of the subject matter described in this specification,) or any combination of one or more such back-end, middleware, or front-end components. The components of the computing system 200 may be interconnected by any form or medium of digital data communication, for example a communication network. Examples of communication networks include a local area network (LAN) and a wide area network (WAN), an inter-network (e.g., the Internet), and peer-to-peer networks (e.g., ad-hoc peer-to-peer, direct peer-to-peer, decentralized peer-to-peer, centralized peer-to-peer, etc.).

The computing system 200 may include clients and servers. A client and server are typically remote from each other and typically interact through a communication network. The relationship of client and server arises by virtue of computer programs running on the respective computers and having a client-server relationship to each other. In some embodiments, a server transmits data (e.g., an HTML webpage) to a client device (e.g., for purposes of displaying data to and receiving user input from a user interacting with the client device). Data generated at the client device (e.g., a result of the user interaction) may be received from the client device at the server.

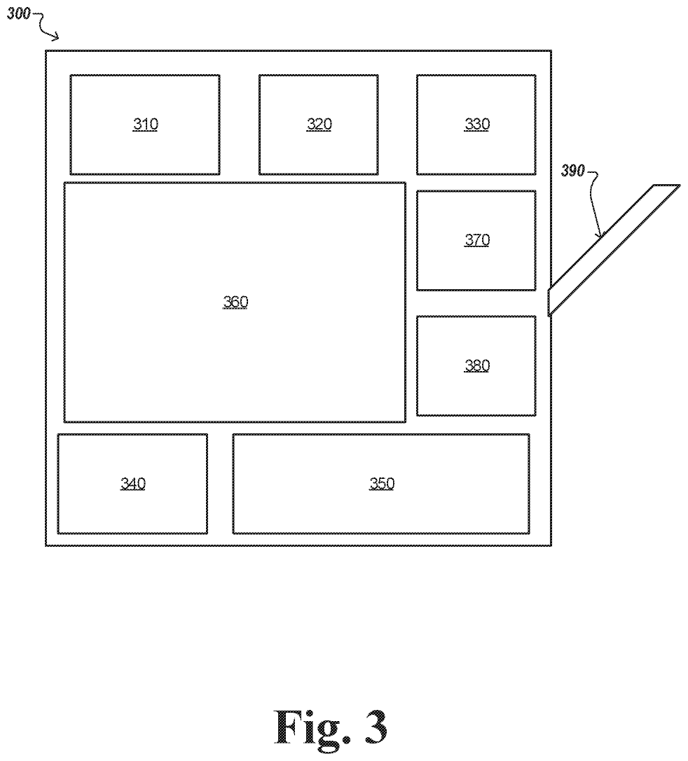

FIG. 3 is a block diagram of an example wearable device 300 used with platform 105, which may include processor(s) 210; memory 220; storage 230; I/O 240; buses 250; data transfer module 310; health module 320 (heartrate monitor, pedometer, altimeter, UV monitor, air quality monitor), location module 330 (GPS); power source 340 (battery, typically rechargeable); notification module 350 (light/tactile/auditory notifier); display 360; input device 370 (buttons, distress signal, etc.); capture module 380 (camera/microphone array, etc.); and/or attachment device 390 (straps, clips, etc.).

Typically, wearable 300 may be attached to a user, and may be a user device 120 in environment 100. For example, wearable 300 typically may use one or more attachment device(s) 390, such as straps, clips, clasps, and/or the like to attach wearable 300 to user, typically in a removable and/or repositionable fashion.

Wearable 300 may typically include one or more data transfer modules 310, which typically may allow wearable 300 to communicate with one or more other devices in a wired and/or wireless fashion, similar to other 3G, 4G, BLUETOOTH, NFC, and/or the like interfaces described in this disclosure. In some implementations, data transfer module 310 may also interface through one or more physical connections (e.g., universal serial bus, bayonet connector, and/or the like). In some further implementations, wearable 300 may also receive power through such interfaces, which typically may then interface with at least power source 340.

Health module 320 typically may be one or more sensors and/or sensor arrays configured to detect, store, analyze, and report data regarding the wearable's user and/or the user's environment. By nonlimiting example, health module 320 may include heartrate monitor(s), pedometer(s), altimeter(s), UV monitor(s), air quality monitor(s), accelerometer(s), biosensors(s), oxygen saturation sensor(s), humidity/moisture sensor(s), sleep sensors, and/or the like. Such sensors on module 320 may typically be used to monitor a user's physical state during activities (e.g., resting heart rate, exercise, sleep cycles, etc.), but this data may also be used longitudinally to help platform 105 determine abnormalities for both health and emergency purposes. In some implementations, one or more modules 320 may be external to wearable 300 and interface with wearable 300 and/or smart device 120.

For example, where a user typically has resting and exercising heart rates of sixty and one-hundred and twenty beats-per-minute, respectively, module's 320 reading of one-hundred and eighty beats-per-minute may signal a health emergency (e.g., panic attack, heart attack, etc.). Similarly, where a user's heart rate is consistent and strong, but during exercise the user's pulse becomes erratic and/or weak, this may suggest a grave health abnormality that platform 105 and/or wearable 300 may notify user of so that user may seek medical attention.

On a personal security side, module 320 may also detect a user enter into an exercise state (e.g., running), where platform 105 knows user's typical heart range and respiration from historical recordings to be in a certain. However, during the exercise, user's step rate decreases rapidly, the accelerometer reads an abrupt halt, and user's heart rate, respiration, and perspiration increase significantly, this may indicate the presence of a hostile actor and/or situation. In such a situation, user may be able to trigger an alert (e.g., using wearable 300 and/or smart device 120); however, in other instances, user may have been attacked or in shock, and platform 105 may trigger an automatic alert to a user's guardian network (explained elsewhere in this disclosure) for aid.

Similarly, where wearable 300 and/or module 320 readings indicate normal resting and/or working parameters for user one moment, and then detect a concussion and rapid increase of vital signs from the user, this could also trigger an alert (e.g., explosion, impact, etc.). In some further instances, such conditions' detection may be transmitted back to system 105, which may then store, analyze, and/or attempt to correlate such data with resources 130 (e.g., social media trends of “explosion,” “gas leak,” “water main,” etc. for a geolocation) and/or other user data and/or alerts.

Location module 330 typically may be a global positioning system (GPS) and/or the like sensor(s) and/or array of sensors to help determine user and/or wearable 300 location. Module 330 may use one sensor (e.g., GPS), while in other implementations, it may use multiple sensors to try to more accurately and/or efficiently determine location. For example, where GPS reception may be limited in an area, but 2G cellular coverage is available for triangulation or open wireless access points are available for connection, such better service may be utilized. This data may then be received, transmitted, and/or stored singularly and/or iteratively to help determine instant and/or historical location data. In some implementations, such location data may then be overlaid on one or more interfaces, such as map view 876 (described elsewhere in this disclosure).

Wearable 300 typically may be energized and/or maintained by one or more power sources 340, such as a battery and/or solar cell. For example, power source 340 may be an embedded alkaline, nickel-metal hydride, lithium ion, polymer, and/or the like cell, which typically may be rechargeable. For example, power source 340 may have exterior connection points for charging, receive power over data interface 310, use induction charging, and/or the like to reenergize power source 340. In some further implementations, where a readily available external power source may not be available, one or more solar cells may be utilized to help charge power source 340 and/or energize wearable 300.

Wearable 300's notification module 350 typically may be one or more notification mechanisms and/or devices to alert user. For example, module 350 may include lights, tactile/vibratory devices, acoustic devices, electrodes, and/or the like to convey notices to user. For example, when a user is a guardian and receives an alert from a guardee, he or she may receive a notice on wearable 300 from module 350 (e.g., vibration, specific vibration pattern, LED illuminates, LED pattern illuminates, acoustic playback, electrical stimulus to skin, etc.).

Similarly, where platform 105 is aware of a public emergency and/or social media trend that may affect user based on proximity, travel path, and/or geolocation, platform 105 may notify user via module 350. For example, a gas pipeline leak that is trending on social media located one-half mile from user, in the direction of user's travel, may trigger an urgent notice to user with a vibration, illumination, and message stating “Emergency alert. Turn around. Danger ahead. Repeat turn around. Danger ahead!”

In some implementations, such notification may be keyed (and/or customized) to a specific event and/or severity. For example, where a minor traffic accident is reported to a public safety system and a detour warning may be issued for an intersection, wearable 300 and/or platform 105 may vibrate gently and inform user to avoid said intersection (e.g., by audio notification, display 360, smart device 120, etc.). Conversely, where a highly dangerous issue is reported (e.g., active shooter, bomb, etc.), wearable 300 and module 350 may sound an aggressive alarm, vibration, and/or even use an emergency stimulus (e.g., minor electrical shock) to quickly and effectively steer user away from danger.

Display 360 may similarly be used to help convey warnings, receive alerts, respond to alerts, check health information, check status of connected devices 120, and/or the like. Display 360 typically may be made of similar display technologies discussed elsewhere in this disclosure and known to those in the art. For example, display 360 may be an OLED panel, bendable, touch enabled, topped with hydrophobic coatings, oleophobic coatings, have abrasive resistance, and/or the like.

In some further implementations, other modules (e.g., modules 310, 320, 330, 340, 350, 370, 380, etc.) may be embedded partially and/or completely within display 360. For example, display 360 may include, but is not limited to, having an embedded UV sensor for health module 320, GPS antenna for location module 340, LED for notification module 350, and/or the like.

Wearable 300 typically may also have one or more input devices 370 to interact with wearable 300. For example, inputs 370 may be physical and/or virtual buttons, switches, and/or like state-toggle devices. In some implementations, input devices 370 may be used to simply acknowledge alerts, timers, location reminders, and/or the like, while in other implementations, they may be used to create, respond to, and/or trigger alerts. For example, an incoming alert 836 from a guardee may trigger a guardian's wearable 300 to vibrate; guardian user may acknowledge triggered alert and view incoming alert 836 with input 370 by pressing and/or otherwise triggering input 370; and wearable 300 may generate and present triggered alert 836 to guardian (e.g., via generated audio message delivered from platform 105, on display 360, and/or the like). Guardian may then review and respond to alert 836, forward it to authorities, try to contact the guardee for more information, and/or take any other action guardian deems necessary.

In another implementation, input devices 370 may be used by a guardee to trigger one or more silent alarms and or alert profiles. For example, where an individual gets into a taxi or ridesharing vehicle and the situation escalates, but the guardee is either not able to escape or not comfortable trying to call for help, she or he may use interact with input device 370 in a predetermined manner (and typically configurable manner) to trigger a silent alert. This, by way of nonlimiting example, may send an emergency SOS beacon to all configured guardians of the guardee; all nearby first responders and/or Good Samaritans on system 105; contact the police and forward location, audiovisual, and other useful data; and/or the like.

In some other implementations, where it may be useful to reduce false transmissions of such beacons, wearable 300 may include multistage verification and/or permissioning. For example, user may also need to enter a pattern on display 360, tap a button on smart device 120, state a discreet code word or phrase (e.g., “Please let me go,” “This isn't the way to my parent's house,” “My favorite president is Warren Harding, what about you,” and/or the like) that is picked up by wearable 300 and/or smart device 120 to then trigger emergency alert beacon.

Wearable 300 typically may also include one or more capture modules 380. Capture modules 380 typically may include one or more cameras, microphones, infrared illuminators, arrays of the same, and/or the like. Module 380 components typically may include optical stabilization, audio normalization, and/or the like to help yield a more understandable audio-video stream.

Such capture devices 380 may typically receive, record, store, analyze, and/or otherwise process wearable 300 surroundings. For example, a runner may use wearable 300 to go for a run and capture modules 380 may record audio and/or video data in continuous and/or looping segments during the run. Such data may be stored locally on wearable 300, to connected smart device 120, and/or uploaded to another device in environment 100. Such audiovisual data may be used to detail a run, help the runner improve their exercise performance, compare vitals at certain parts of the routine, and/or the like.

However, such data may be extremely useful where the user is threatened, harassed, attacked, and/or otherwise confronted. Where the module 380 is looping, the user may trigger wearable 300 (e.g., using input 370) to keep prepended data and keep recording, send an alert with the prepended data, and/or the like. Wearable 300 may also be aimed toward assailant to take a picture or video using module 380, turn on a warning siren, turn on a bright LED to temporarily visually incapacitate the assailant, and/or the like to help document the encounter and hopefully escape. Wearable 300 may similarly connect with and utilize smart device 120 to store, analyze, and transmit data, as well as use connected external user capture devices 120 (e.g., devices 440 in device list 430, described elsewhere in disclosure) to have one or more audio/video streams that may be of better quality, higher priority, better visibility, and/or the like. Such prioritization of devices 120 may, in some implementations, use emergency optimization algorithms (described elsewhere in this disclosure).

Attachment device 390 typically may be one or more structures that aid user in attaching wearable 300 to user for use. For example, such attachment members 390 may be straps, clips, fasteners, magnetic elements, and/or the like. Attachment devices 390 typically may allow wearable 300 to remain substantially stable and connected to user, and may be modulated in some implementations to more or less securely restrain wearable 300, depending on the situation. For example, where wearable 300 is configured in a typical watch-like format, attachments 390 may be one or more watchbands. In a lapel-like configuration, wearable 300 may connect using one or more pins and/or magnetic elements through a user's clothing. In yet another implementation, where wearable 300 is worn on the shoulder, attachments 390 may loop around arm, shoulder, and/or through clothing. However, it is understood that wearable 300 and attachments 390 may be configured in many formats to best optimize use cases and efficacy of the wearable 300 and user protection.

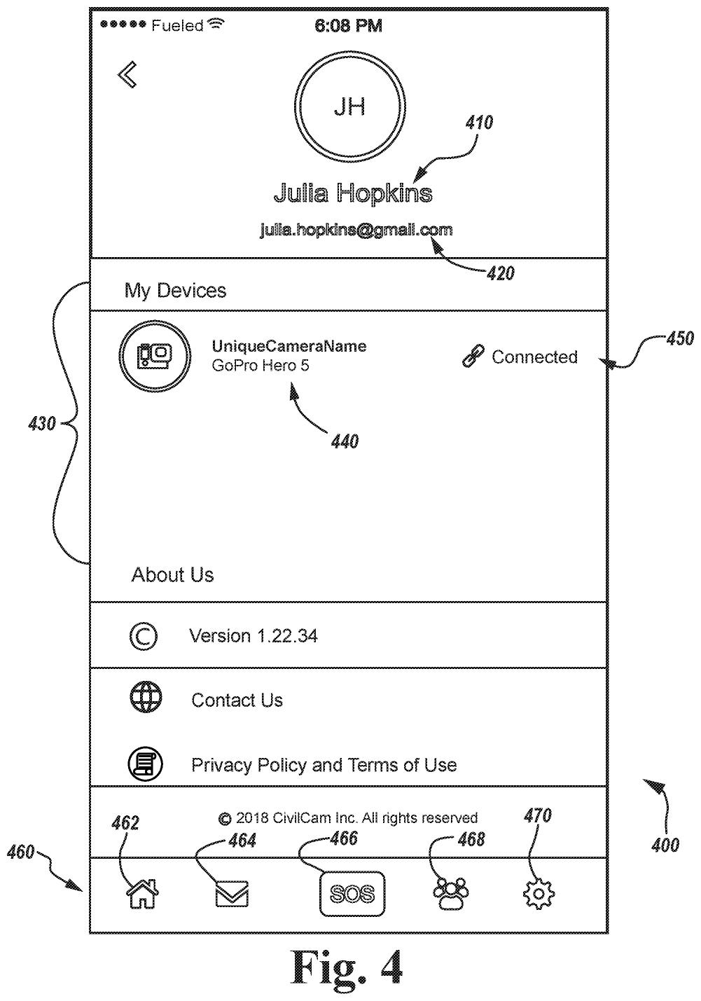

FIG. 4 depicts a first screenshot associated with user accounts on the platform 105, which typically may be user account screen 400. User account screen 400 typically may include user 410; user email 420; devices list 430; device ID 440; connection state 450; navigation bar 460; home icon 462; notifications icon 464; SOS icon 466; users and groups icon 468; and/or settings icon 470.

User account 400 typically may be an interface as presented on user device 120, wearable display 360, and/or the like. Screen 400 typically may pull user 410 and user email 420 from system data 165 and/or user data 170 to populate screen 400. In some implementations, one or more icons and/or avatars may represent user 410 to quickly and efficiency allow identification of user 410 where space or at-distance recognition, such as on display 360, may be beneficial or desired.

Devices list 430, device IDs 440, and connection states 450 may typically denote devices 440 associated with and/or connected to platform 105 and associated with user 410. For example, as depicted in FIG. 4, a user may have one or more devices 120 and/or wearables 300 (e.g., lapel camera, lapel microphone, shoulder camera, glass frame camera, headlamp camera, personal body cam, three-hundred and sixty-degree camera, GOPRO HERO 5 (GOPRO is a registered trademark of GoPro Inc., a Delaware corporation, located at 3000 Clearview Way, San Mateo, Calif. 94402), and/or the like) configured for use and/or connected. Such devices 120, 300 may include cameras, microphones, sensors, and/or the like. One or more of the devices may, once connected to platform 105 (typically through one or more software applications on end user device 120 and/or encoded on the devices 120, 300 themselves as software, firmware, etc.

Typically, when multiple devices 120 (represented typically as multiple device IDs 440 in device list 430) are available for use, user 410 and/or platform 105 may prioritize usage in capture scenarios. By way of nonlimiting example, on a smart phone having both front- and rear-facing cameras, as well as a microphone, dual recording may be done using both cameras and streamed over environment 100; one camera may record locally while the other streams over environment; both cameras may record locally until a data connection having sufficient bandwidth is available to transmit one or both saved streams; both cameras may record but platform 105 may selectively transmit only optimized still images and/or snippets of the audiovisual stream (optimization discussed elsewhere in this disclosure); only one camera having the most optimized stream quality and/or bandwidth may capture and stream; both cameras may capture locally but only all or part of the audio stream may be sent over environment 100; and/or the like. In instances with multiple microphones, arrays, sensor(s), cameras external to user device 120, and/or the like, similar prioritization and optimization may occur to provide the most pertinent audio, video, and vital data in an emergency event.

Further on account screen 400 typically may be navigation bar 460, which typically may include home icon 462, notifications icon 464, SOS icon 466, users and groups icon 468, and/or settings icon 470. Navigation bar 460 typically may be located at the footer of the application screen 400, but may be moved, resized, hidden, and/or otherwise modified as desired.

Home icon 462 typically, when selected by a user, may return user to a general interface (such as, but not limited to, my account screen 400, user list screen 500, notifications screen 700, and/or the like). Notifications icon 464 typically, when selected by a user, may navigate user to notifications screen 700, where user may typically view notifications associated with user 410 on platform 105.

SOS icon 466 typically, when selected by a user, may trigger an emergency alert, a preconfigured alert by user 410, navigate user to ongoing guardee emergency screens, and/or other relevant emergency screen. In some implementations, pressing and holding SOS icon 466 may trigger a variety of configurable actions, such as an emergency beacon to all guardians, immediately send situational data to E911 service, trigger silent alert, trigger loud siren and/or lights, and/or the like.

Users and groups icon 468 typically, when selected by user 410, may navigate interface to user list screen 500 and/or guardian list screen 540, discussed in greater detail elsewhere in disclosure. Settings icon 470 typically may navigate user 410 to an interface having one or more settings for user 410 account and/or software application settings on platform (e.g., draw over other apps capability, data usage, personal data, home address, and/or the like). In some implementations, settings icon 470 may navigate to my account screen 400.

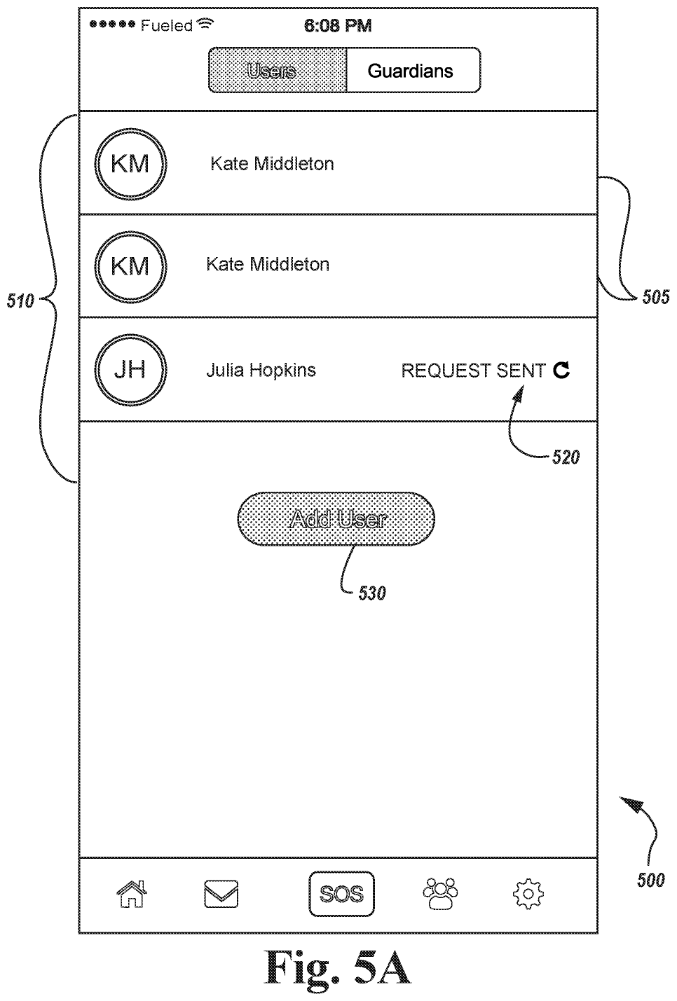

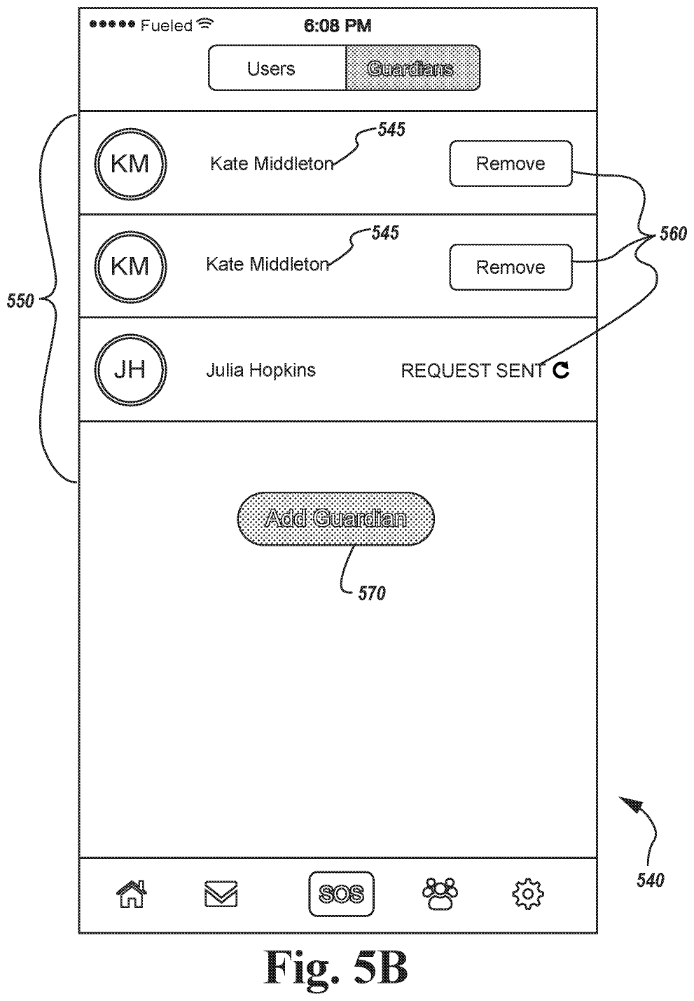

FIGS. 5A and 5B depict screenshots associated with users and guardians on system 105. FIG. 5A typically includes my users list screen 500; user guardees 505; user list 510; user status 520 (typically connected, blank, or request sent); and/or add user button 530. FIG. 5B typically includes my guardians list screen 540; guardians 545; guardian list 550; guardian status 560 (typically request sent or remove); and/or add guardian button 570.

My users list screen 500 typically may present user list 510 typically including one or more guardee users 505 that the active user 410 account is associated with as a guardian (i.e., the present user 410 is a guardian and users list 510 includes guardees 505). User status 520 may typically indicate the current condition of such connection, and typically may indicate connected, blank, and/or request sent. A blank or connected status 520 typically may mean that the present user 410 has agreed to be a guardian of the user list 510 guardee 505, while a request sent and/or revoked condition status 520 may indicate that the relationship is either not yet verified or has been rescinded. In some implementations, revoking the relationship may simply remove guardee 505 from the user list 510, and in some other implementations, the revocation may appear in one or more notifications to user 410 (e.g., in guardee termination notification 720, described elsewhere in disclosure).

Add user button 530 typically may be used to add a new guardee and/or initiate such guardee-guardian relationship with another platform 105 user. Guardees 505 to add may, for example, be presented based on the user device 120 address book, by entering a platform 105 username, by entering a platform 105 user's real name, etc. For example, a parent user 410 may add a child guardee 505; child user 410 may add elderly guardee 505; elder care worker 410 may add elder patient 505; and/or the like. After adding user with button 530, guardee 505 may typically receive a verification notification, and then may click and/or otherwise acknowledge relationship. In some implementations, such as with a parent-child relationship, the guardee 505 account may be ancillarily controlled by the parent user 410 account and/or automatically be configured to accept guardianship from a predefined set of platform 105 accounts, usernames, real names, phone numbers, associated user emails 420, and/or the like.

FIG. 5B typically includes my guardians list screen 540, which may typically act somewhat in the inverse of user list 500. Guardian list 550 typically may list one or more platform users 410 that are guardians 545 of the current user 410. Effectively, this is the other side of the balance if two users were guarding each other; user A 410 would see user B in their guardee list 500 guarding user A, and user A would also see user B in their guardians list 540 guarding user A. Guardian status 560, similar to before, typically may show the relationship condition, such as connected, request sent, etc.

In some implementations, where user 410 wants to remove a guardian (e.g., user B 410) from their guardian list 540 and thus break that relationship, user 410 status may be listed as “Remove” (i.e., indicating valid relationship exists) and user 410 may then click Remove button 560 to break relationship. In some implementations, guardians 545 may not be removable based on relationship type (e.g., caretaker-patient, parent-dependent, officer-parolee, etc.), and in other implementations, such removal may require further verification steps (e.g., patient recovery, dependent age, etc.).

Add guardian button 570 may typically act similarly to add user button 530 described above to add a new guardian and/or initiate such guardee-guardian relationship with another platform 105 user.

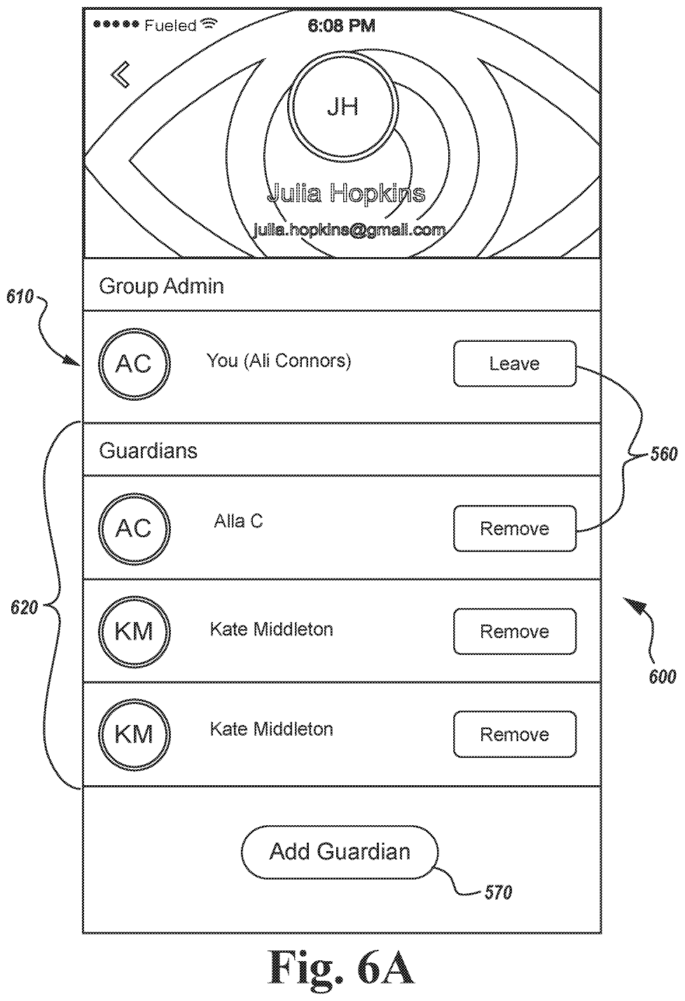

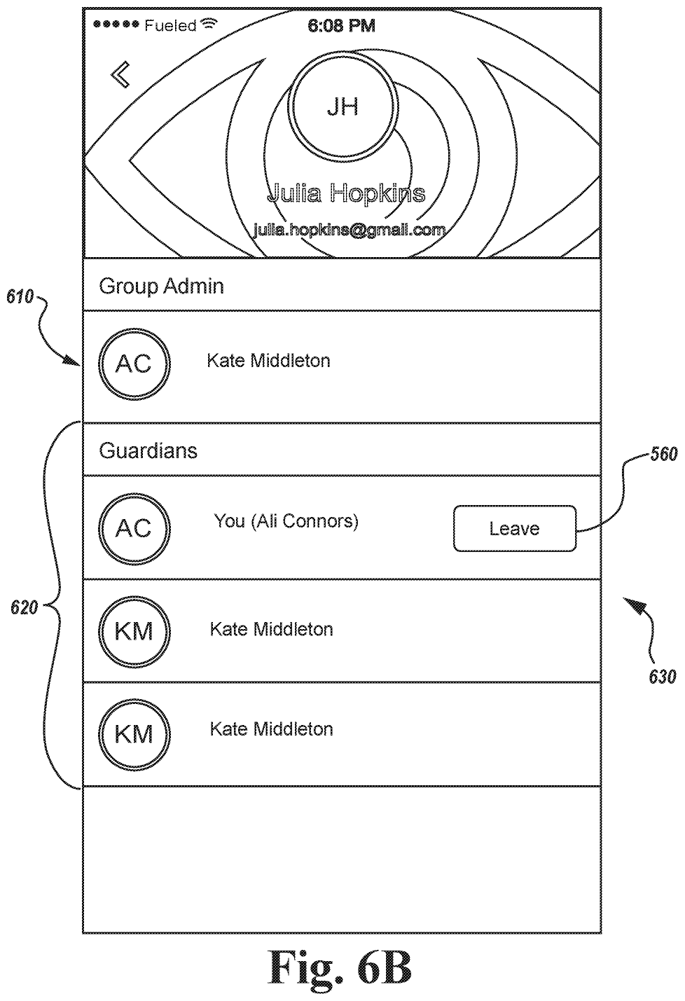

FIGS. 6A and 6B typically depict screenshots associated with user group on platform 105, which typically may include admin group list screen 600 and nonadmin group list screen 630.

Admin group list screen 600 may typically include group admin 610, group guardian(s) 620, guardian status 560, and add guardian button 570. In the case of admin group list screen 600, the current user 410 may typically also be listed as group admin 610, providing user 410 with role permissions to add, remove, and/or otherwise modify the group. Groups typically may be set up to allow the group admin 610 to easily administer known relationships and/or predefined platform 105 user groups. For example, a runners' group may form a platform 105 group, elect an admin 610 (who may be the individual best known, most knowledgeable with platform, most centrally located, arbitrarily selected, etc.), and the rest of the runners are listed as group guardians 620. User 410 may, in some implementations, maintain one or many such groups, and trigger groups globally, individually, and/or by subsets thereof.

Similarly, nonadmin group list screen 630 may typically include group admin 610, group guardian(s) 620, and/or guardian status 560. This screen 630 typically may be functionally similar to screen 600, but where user 410 is not the admin 610, they no longer have the ability to remove other guardians 620 from the group. User 410 typically may still remove herself or himself though (assuming removal permissions or group controls do not otherwise exclude such actions). For example, in a suicide or addiction help group, a group member may not be allowed to arbitrarily leave the group without first discussing with their sponsor, or in the case of a sponsor, without transferring their sponsee to another sponsor in the group, etc.

In some further implementations, groups may additionally include “check in” or safety verification mechanisms. For example, a runners group may allow runners to each check in and verify that each runner got home safely; addiction recovery groups may have a daily check in to aid in mindfulness and accountability; children may check in once arriving home or to a friend's house; and/or the like. Similarly, in a public emergency situation (e.g., a shooting at a school); children could easily check in with parents, teachers may get a virtual “count off” from their students even if students are not in a lockdown scenario; administrators/teachers may give send reports to authorities to help coordinate rescue and/or recovery efforts; and/or the like.

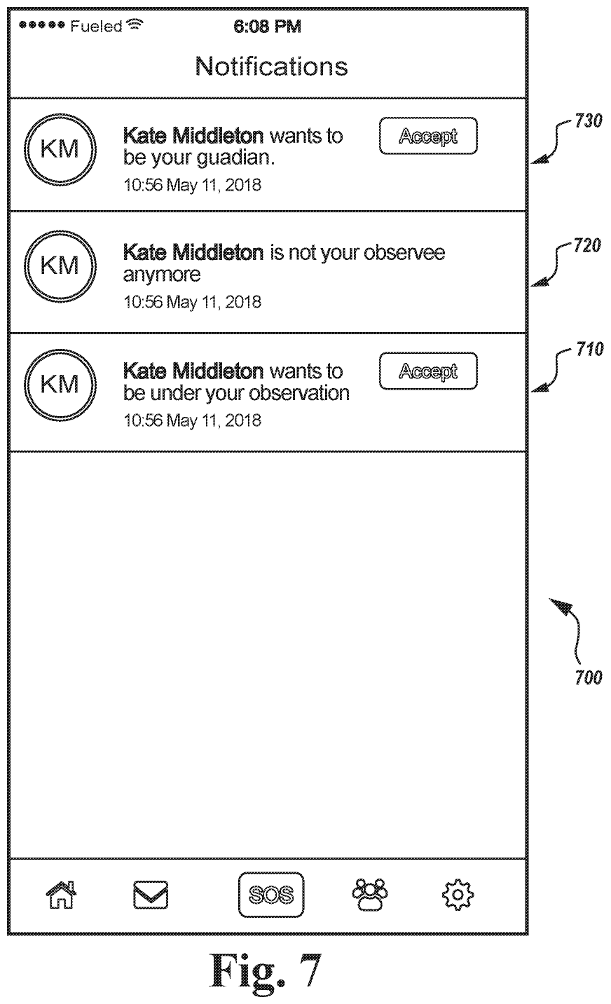

FIG. 7 depicts another screenshot associated with notifications screen 700 on system 105, which typically may include guardee request notification 710, guardee termination notification 720, and/or guardian request notification 730.

Typically related to activities described above in this disclosure, guardee request notification 710 typically may appear when one or more other users 410 request that the current user 410 act as a guardian 545 to the guardee user 505. Guardee termination notification 720 typically may be generated and appear when one or more users 410 terminate the guardian-guardee relationship with their guardian 545 (i.e., the guardee 505 terminates the guardian 545 user's status).

Guardian request notification 730 typically may appear when a user 410 requests to be the current user's 410 guardian (i.e., to make the current user 410 a guardee of the requesting user 410). In some implementations, notifications screen 700 may be alternatively generated and/or presented. For example, notifications 700 may be processed as audio and presented over one or more smart home devices 120; sent to and/or change inputs a smart television and/or monitor 120; sent to a public broadcast; and/or the like.

Further examples of notifications that may appear in notifications screen 700 may be public safety alerts; relevant social media trends; triggered alerts from guardians 545 and/or guardees 505; guardian 545 terminates relationship; a group needs a new admin 610; a group guardian 620 transmits a message; a group guardian 620 is added; a group guardian 620 is removed; user devices 120 are added, removed, connected, disconnected, modified, etc.; new platform 105 features are added; audio/video features are matched to known geolocations from third-party repositories and/or learning data 175; platform 105 requests user 410 to identify landmarks in audiovisual data streams for learning datastore 175; and/or the like.

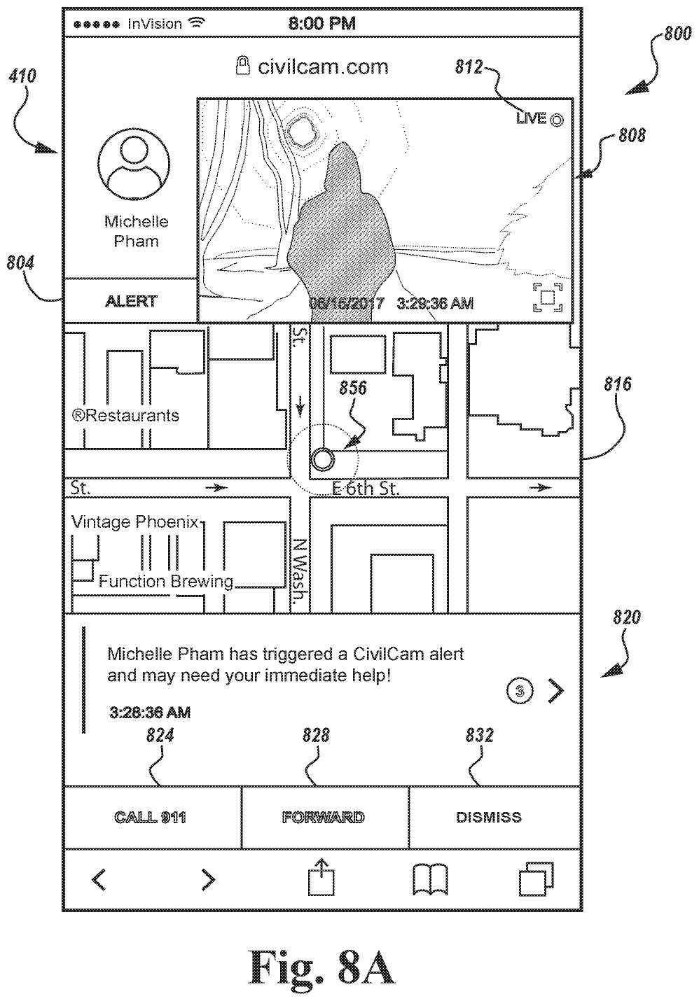

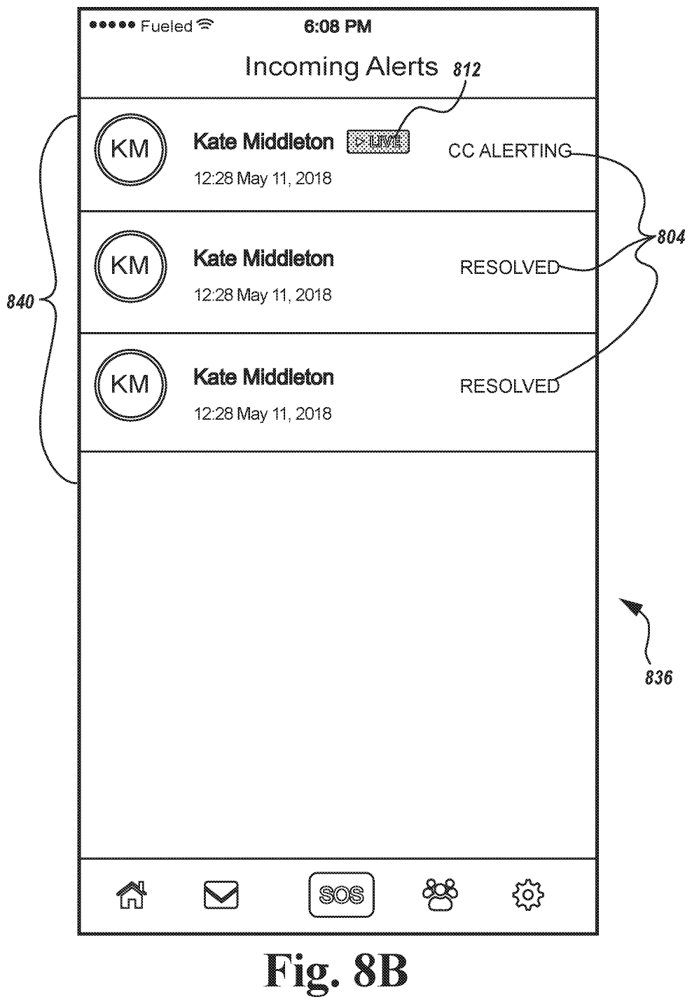

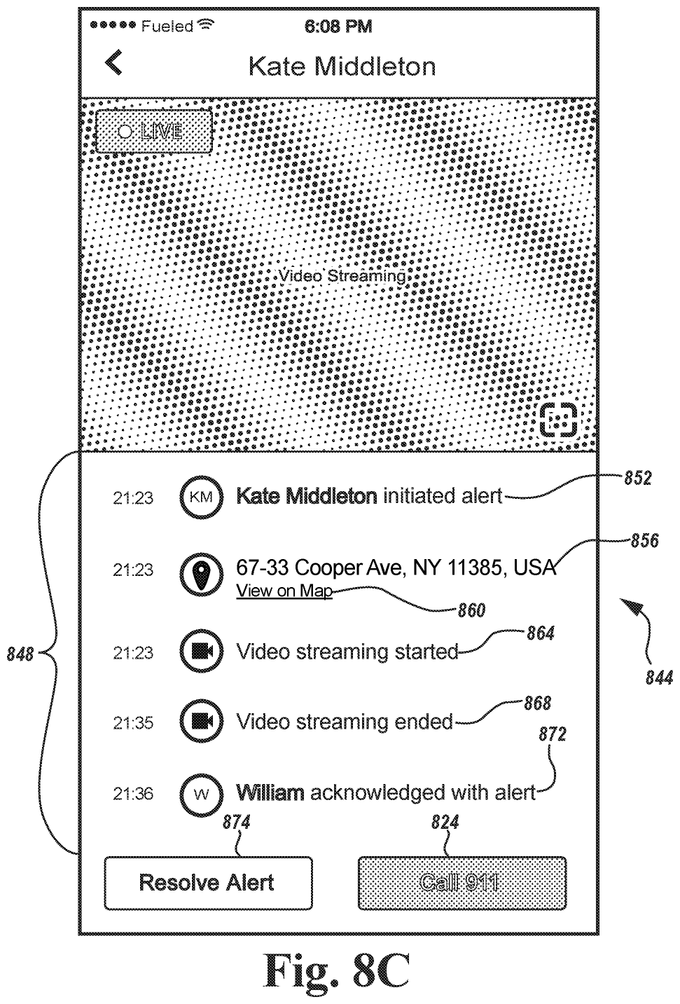

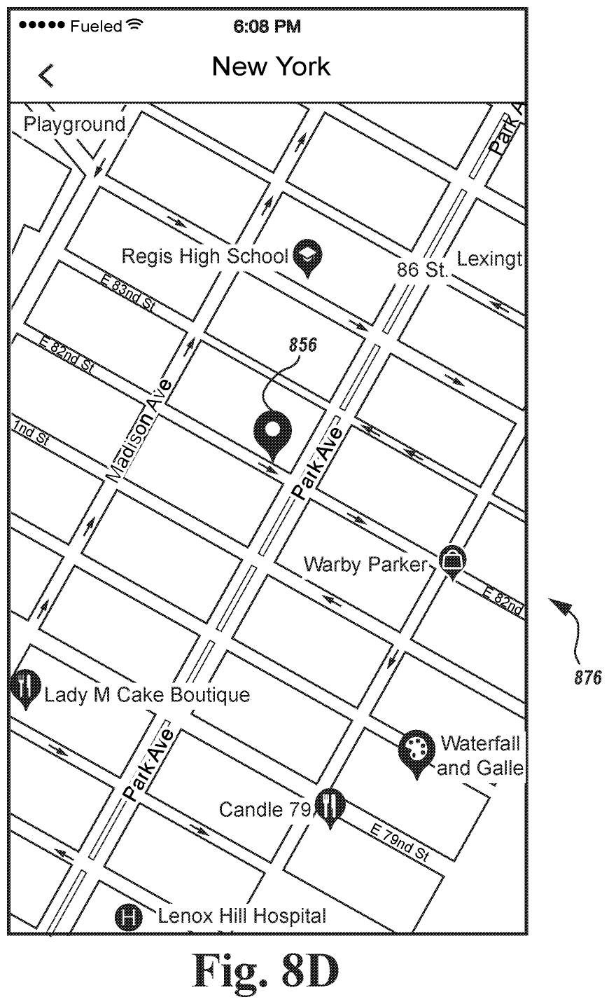

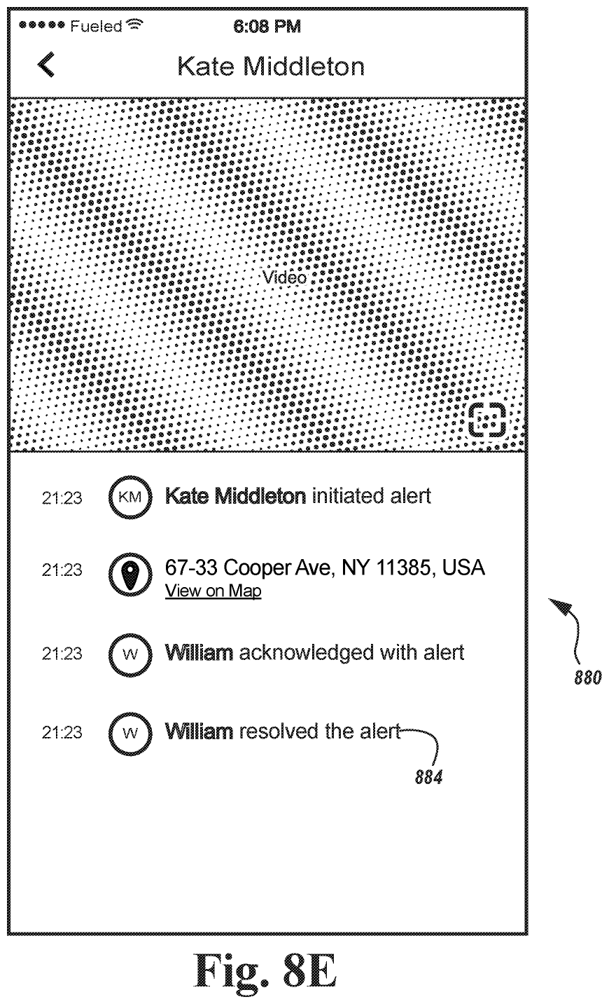

FIG. 8A depicts a further screenshot associated with triggered alerts on platform 105. Triggered alert screen 800 typically may include guardee 505/user 410; alert status 804; audiovisual feed 808; feed status 812; guardee location panel 816; alert status feed 820; E911 referral button 824; forward alert button 828; and/or dismiss alert button 832.

Guardee 505/user 410 typically may initiate one or more triggered alerts, which may then typically be routed through platform 105 and to one or more guardians 545 (and/or group guardians 620). Guardians 545, 620 typically may then receive alert notification (on device 120, wearable 300, etc.) and be presented with alert screen 800. Alert screen 800 may typically provide current and/or nearly current data regarding guardee 505 status, location, alert type, audiovisual data, and/or the like for review by guardian(s) 545, 610.

Alert status 804 typically may be the current status of the triggered alert on alert screen 800. For example, status 804 may be “active,” “dismissed,” “resolved,” “forwarded to E911,” and/or the like. Such status 804 may typically act to inform guardians 545, 620 at a glance about the actions taken, or not taken, to the current point in time.

Audiovisual feed 808 typically may be one or more audio/video streams from user device 120, wearable 300, and/or the like that guardee 505 has transmitted over environment 100 and/or platform 105 to guardians 545, 620. For example, this may be a live fee from guardee 505 smartphone 120 camera, externally connected camera 120, wearable 300 capture module 380, and/or the like.

In some implementations, depending on the status of the feed, connection quality, type of alert (e.g., minor, emergency, SOS, etc.), feed 808 may be optimized to better capture the most pertinent details of the stream 808. For example, edge detection of a probably human face, outline of a human body, tattoo and/or design on human skin, clothing design, height relative to known objects in adjacent-field view, and/or the like may be prioritized, selectively recaptured, selected based on connected device 120 field of view and/or focus (i.e., where one camera is obscured by clothing or in a pocket, but another camera detects probable active human outline(s), system 105 may automatically prioritize and optimize stream for said other camera), and/or the like.

Feed status 812 typically may represent the current state of feed 808. For example, status 812 may be live (where current stream 808 data is being transmitted); cached (where stream has ceased but prior stream data 808 is available to review); recorded at XX:XX (where stream 808 is archived and timestamped for review); and/or the like.

Guardee location panel 816 typically may visually depict at a glance the current location 856 (and/or historical location 856) of guardee 505. This may typically be depicted on a visual map, typically sourced from user device 120 itself, resource(s) 130, index 140, and/or platform 105 datastores. In some implementations, where historical location 856 may be depicted, projected trajectory of location 856, current speed of travel, last known open wireless access point SSID, and/or other useful location-identification data may also be presented.

Alert status feed 820 typically may be one or more textual notifications, similar to notification feed 700, which may typically inform guardian 545, 620 of alert timelines, specifics, severity, response by other guardians 545, 620, and/or the like.

Depending on the situational severity, E911 referral button 824 typically may allow guardians 545, 620 to forward the triggered alert and associated data (location, time, audiovisual data, etc.) to one or more connected E911 systems 155, escalating to authorities that may be more capable of resolving the alert. For example, where a guardian 545, 620 views and/or hears a gun firing in feed 808; hears guardee 505 begging to be released; hears discussion of “hostages” and/or similar extremely serious circumstances that guardians 545, 620 may not be capable of handling, use of the E911 button 824 may be preferential and/or necessary.

Similarly, forward alert button 828 typically may be used to forward the triggered alert and/or details to another user 410 on platform 105 and/or in some implementations, to another user outside of platform 105 (e.g., guardee 505 parent). In some implementations, for jurisdictional and/or other legal considerations, certain platform 105 features may be limited (e.g., recording screen, feed 808, and/or the like; parent may simply be given child location and ability to forward to E911 system 155, and/or the like).

Further, interface 800 may also include dismiss alert button 832, which typically may be used by the guardee 505 and/or one or more guardians 545, 620 to dismiss one or more alerts. For example, where an alert has been resolved (e.g., police have arrived, etc.); alert was accidental (e.g., inadvertent pocket-triggered alert, wearable 300 fell down stairs and triggered alert, and/or the like); and/or other instances where guardian 545, 620 reasonably believes triggered alert to be resolved and/or a false alarm.

As described elsewhere in this disclosure, some implementations may utilize and/or enforce multiple-stage clearance and/or verification procedures to prevent an attacker from clearing an alert (e.g., using guardee 505 wearable 300 or smart device 120); maliciously clearing an alert by a guardee 505 (e.g., where guardian 545 is a group guardian 620 of guardee 505 and in bad relationship, etc.); where organizational procedures call for supervisor clearance as well (e.g., in a nursing home, school system, police environment); and/or other such situations where multiple dismissal protocols may be desired.

FIG. 8B depicts a screenshot associated with incoming alerts screen 836 on platform 105, which typically may include alerts list 840; alert status 804; and/or feed status 812. Incoming alerts screen 836 typically may act similarly to notifications list 700, providing details regarding alerts from other guardees 505 and/or guardians 545, 620. For example, as depicted incoming alerts list 840 may include one or more alerts from one or more users 410, as well as the status 804 of each of those alerts. A user 410 may then click and/or otherwise select an alert to view the current details and/or feed 808 (e.g., as in incoming alert screen 800).

FIG. 8C typically depicts a screenshot associated with alarming alerts screen 844 on platform 105. Alarming alerts screen 844 typically may include—in some implementations along with stream 808 and/or stream status 812—one or more chronological alert timelines 848; alert initiation 852; guardee location 856; location link 860; feed start status 864; feed close status 868; and/or guardian acknowledgment 872. Alarming alerts screen 844 may typically be another implementations of screen 800, providing a condensed chronological timeline 848 and time stamps for actions performed with regard to the triggered alert.

For example, alert initiation 852 may typically indicate when and who initiated an alert. This typically may be one of current user's 410 guardees 505. Typically at or about the same time, guardee location 856 and/or location link 860 may then be queried and/or populated, providing a current, or as-current as possible, location of guardee 505. In some implementations, guardee location 856 and/or location link 860 may be updated depending on changes in guardee location 856. Location link 860 typically may be a hyperlink and/or the like, which when selected may typically navigate and/or open a current map view of location 856 (e.g., as in map view 876).

Feed start status 864 and feed close status 868 typically may indicate when, where, and/or how stream 808 was initiated and terminated. For example, stream 808 may have been initiated by an SOS command, by silent wearable 300 trigger, and/or the like at 21:23 in audiovideo mode. In another nonlimiting example, stream may simply be an audio stream with a single optimized, attached image of a potential assailant. Stream termination 868 may then indicate full and/or partial stream loss. For example, device 120 lost signal completely but was shifted to local recording; device 120 was turned off; wearable 300 experienced sudden acceleration and then lost signal; connected camera 120 lost video and disconnected; guardian 545, 620 dismissed alert; and/or the like.

Guardian acknowledgment 872 typically may indicate that one or more guardians 545, 620 have received, reviewed, and/or acknowledged the triggered alert at a given time. Such acknowledgment 872 may, in some implementations, also include specifics of the guardian 545, 620 acknowledgements (e.g., dismissed alert as accidental trigger, contacted guardee 505 successfully, forwarded to E911 155, and/or the like).

FIG. 8D typically depicts an example screenshot associated with map alerts view screen 876 on platform 105, which typically may also depict guardee location 856. As discussed elsewhere in this disclosure, screen 876 may be used to view guardee 505 and/or guardian 545, 620 current, historical, and/or projected future geolocation. In some implementations, data regarding movements, such as speed, trajectory, nearby landmarks, elevation, and/or the like may also be provided.

In further implementations, past, present, and/or projected public safety warnings, geofences, and/or the like may also be generated and/or presented on screen 876. For example, where a social media trend is detected by system 105 regarding an active shooter situation and geolocation(s) are deemed unsafe by system 105 (e.g., using public safety announcement, learning data 175 on system 105, and/or the like), such unsafe geofenced locations or shelter locations may be overlaid and presented on screen 876 in relation to user location 856.

FIG. 8E depicts another screenshot associated with resolved alerts screen 880 on platform 105, which typically may include guardian resolution 884. Typically similar to notifications screen 700 and/or alert timeline 848, resolved alerts screen 880 may typically detail a historical alert timeline 848 of a resolved alert after one or more users 410 submit one or more guardian resolutions 884. Such archived timelines 848 may, for example, be useful in determining past triggered alarm timelines for authorities and/or guardians 545, 620 to help piece together a personal and/or public safety alert on system 105.

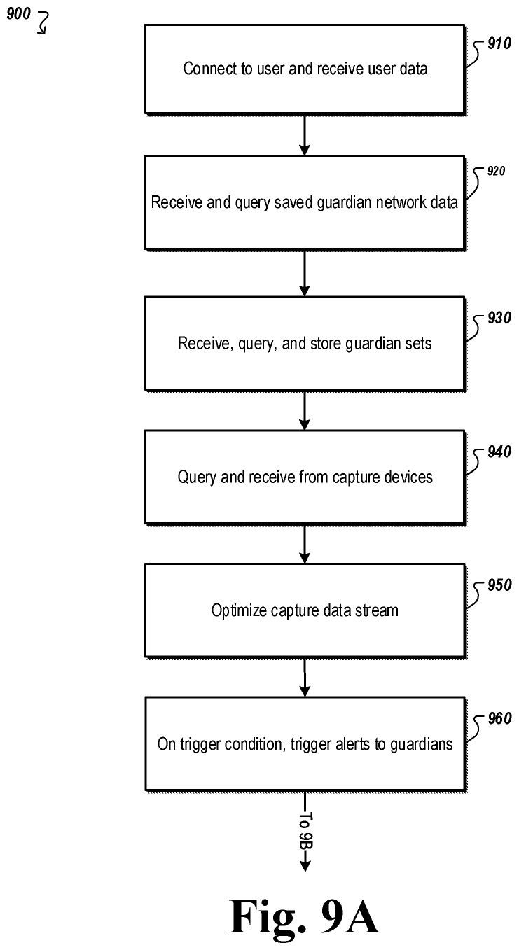

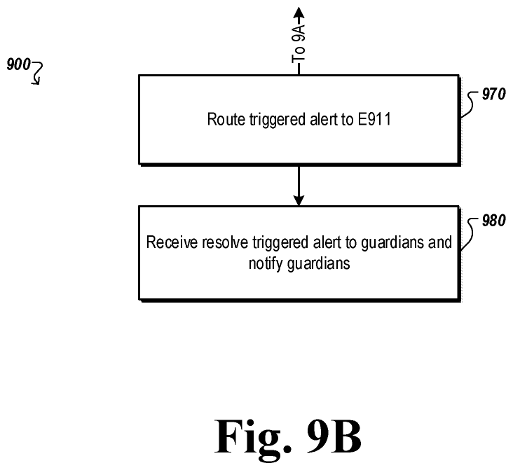

FIGS. 9A and 9B typically depict a process flow associated with the platform 105. Platform process flow 900 typically may include the steps of ‘connect to user and receive user data’ 910; ‘receive and query saved guardian network data’ 920; ‘receive, query, and store guardian sets’ 930; ‘query and receive from capture devices’ 940; ‘optimize capture data stream’ 950; ‘on trigger condition, trigger alerts to guardians’ 960; ‘route triggered alert to E911’ 970; and/or ‘receive resolve triggered alert to guardians and notify guardians’ 980.

During ‘connect to user and receive user data’ step 910, system 105 may typically receive user 410 credentials, query system database 165 and/or user database 170, and authenticate user 410, typically using credentials, passkeys, smart ID, and/or the like. User 410, typically using user device 120, may provide personal data (e.g., user 410 name, email address 420, home address, profile picture/avatar, and/or the like) to system 105. System 105 may then store that data on associated datastores.

Further, during the ‘receive and query saved guardian network data’ step 920, system 105 may typically query datastores 165, 170 for one or more guardian-guardee relationships established with user 410 account. Platform 105 may then typically transmit such stored relationships to user devices 120 for review.

During ‘receive, query, and store guardian sets’ step 930, user 410 may also provide, amend, create, delete, and/or otherwise modify such guardian network relationships associated with his or her user 410 account on platform 105. For example, user 410 may create add his or her spouse as a guardian 545, a parent may add his or her child as a guardee 505, a caretaker may add a patient as a guardee 505, a runner may add his roommate as a guardian 505, and/or the like. These relationships may be added as individual datastores associations (e.g., for privacy); associated with the user 410 in a table store for the user 410 broadly; and/or in some implementations, obfuscated with hashes and/or encryption to further protect privacy.

Guardian sets may also include guardian-guardee groups. For example, user 410 may create a runners' group, assume the role of group admin 610, and invite other runners that are users 410 on platform 105 as group guardians 620 and/or guardees 505. Similarly, user 410 may join and/or be invited to join a group as a group guardian 620 but not a group administrator 610. These relationship sets and groups may similarly be stored on system databases 165, 170.

Additionally, during the ‘query and receive from capture devices’ step 940, system 105 may typically query user device 120 and/or wearable 300 for connected and/or available capture devices. For example, such capture devices 120 may be front- and/or rear-facing smartphone cameras, head-mounted cameras, wearable 300 capture module(s) 380, and/or the like.

In some implementations, capture devices 120 may be prioritized and/or optimized according to capture device 120 specifics, for example as may be stored in datastores 165, 170, 175. By nonlimiting example, a higher-resolution camera sensor may be prioritized over a lower-resolution sensor in general; a wider capture angle camera lens may be prioritized over a narrow field of view where distortion is less of a concern (e.g., in an outdoor scene); a camera sensor having a greater light sensitivity may be prioritized over a less sensitive camera sensor in a low-light environment; a high refresh rate sensor may be prioritized where system 105 and/or device 120 detects acceleration, motion blur, and/or the like; a device 120 capable of greater compression without quality loss (e.g., H.265 compared to H.264 compared to MJPEG, etc.), which may typically allow for higher quality at a lower bitrate (but often at a higher computational cost). Such prioritization profiles may be learned over time as well and stored for recall, analysis, comparison, etc. in learning datastore 175.

Conversely, high computational codecs may be prioritized at a lower level where a user device 120 is low on battery, not optimized for use of that codec (but may, for example, have hardware encoding and decoded on chipset for H.264), and/or the like where such may be a hindrance to efficiently and effectively transmitting the most optimized data in an emergency over system 105.

During ‘optimize capture data stream’ step 950, system 105 and/or device 120 may typically receive and process one or more capture streams 808 from one or more devices 120, 300.

In some implementations, machine-learning techniques may be used to select relevant audiovisual data, such as using neural networks (e.g., supervised learning networks, convolutional neural networks, deep learning neutral networks, etc.), clustering, genetic algorithms, and/or the like. Using such techniques may reduce connection lag, increase throughput over conventional systems; reduce bandwidth necessary to communicate in an emergency situation; simplify connection routines for users on platform 105; naturally filter for the best performing hardware devices without expert knowledge; greatly improve location and object identification; better focus limited processing power on the goal of preserving identifying characteristics of a user's 410 environment and/or assailant; and/or the like. Such aspects and data typically may be stored for use in learning datastore 175.

Such processing may, by nonlimiting example, use techniques such as shader normalization; value thresholding; contour detection; interest point mapping, indexing, and segmentation; template similarity consensus matching; composite operation algorithms; comparison of notable feature vectors; dimensional extrapolation and pose estimation; context-based image retrieval and comparison; and/or the like.

In one such nonlimiting use case, system 105 optimization techniques may be used to improve assailant detection and/or mapping by using silhouette detection, more specifically human silhouette detection. For example, a runner may use a head-mounted camera capture device 120 while jogging on a trail, which may typically loop recordings until the camera 120 detects the presence of a human silhouette (using edge detection, template recognition, neural profiles, and/or the like) to begin recording the individual and interaction. System 105 optimization may further scan for, focus on, and identify personally identifying characteristics, such as tattoos, abnormalities on the skin (e.g., birth marks, scars, etc.), and specifically focus processing power on capturing, smoothing, and transmitting such identifying features, which are typically incredibly useful to police investigations and/or prosecution. Over time, such optimization may be further compounded using neural advancement and optimization using datastore 175.

In another optimization situation of system 105, devices 120 may be used to perform relative height analysis based on a user 410 surroundings. For example, where a user 410 has input his or her height, or where device 120 includes ranging and/or altimeter sensors, stream 808 data may be analyzed for relative height characteristics of other individuals to provide physical characteristics of an attacker. For example, by triangulation from the user 410 height, a cameras field of view, a gyroscopic sensor's reading, and a nearby landmark (e.g., a stop sign, tree, and/or the like), system 105 may then determine that an approaching individual may be an extrapolated height based on the system 105 optimization algorithms. In some other implementations, such algorithms may also be adapted to determine height based on other extrapolative measures, such as gait, shadow throw, and/or the like.

In yet another optimization scenario, stream 808 may be used to specifically scan for, focus on, and identify certain clothing and/or apparel. For example, system 105 may use stream 808 to identify a specific brand of clothing, a unique model of sneaker, a specific type of eyeglasses, a logo for a business, unique colors associated with only certain brands or logos, and/or the like. These identifying features may, again, be given higher prioritization for capture, processing, storage, and transfer to better identify and/or prosecute a culprit.

Still further implementations may also integrate the use of known-positive image repositories to identify geolocations based on known landmarks. For example, where GPS reception is unavailable and a user 410 location is unknown, a stream 808 (or subset thereof) may be transmitted to an image repository to compare identifiable landmarks within stream 808. For example, in one such example, a church steeple may appear over the top of an assailant in a stream 808, which the repository may be able to match to a more specific geolocation so that guardians 545, 620 and/or authorities may begin searching for guardee 505 near that location.

In still further implementations, system 105 optimization may be used for contact area recognition and forensic analysis. For example, stream 808 may depict an assailant grasping a lamppost at approximately seven feet above street level, where a forensic analysis may never think to test for biometric evidence. Or, in another example, an assailant may be struck by guardee 505 and spit blood into a patch of grass that may otherwise be overlooked by police and be highly useful to identification of the suspect.

In some implementations, one or more such optimization profiles may be used serially and/or in parallel. For example, once system 105 has obtained a clear and unblurred capture of the suspect's face, system 105 may them use an optimization routine to search for identifying physical characteristics (e.g., tattoos, piercings, etc.). Upon finding no other identifying physical characteristics, an optimization protocol searching for identifiable apparel or clothing may commence, identifying a specific brand of wrist watch and sneaker. This process may cycle through various prioritized devices 120 based on each device's 120 relative uses, connection status, clear field of views, and/or the like as known to platform 105 (and typically stored in learning datastore 175).

In the ‘on trigger condition, trigger alerts to guardians’ step 960, system 105 typically may send one or more alerts to guardians 545, 620 associated with user 410 and/or a group of which user 410 is a member. Guardians 545, 620 typically may then receive a notification on their user devices 120, 300 indicating the triggered alert, the triggering guardee 505, details regarding the alert, and, typically, either be presented with or given a link to alert screen 800, 836, 844, 876, etc.

In some implementations, where escalation of a triggered alert to the E911 system 155 may occur, ‘route triggered alert to E911’ step 970 typically may be performed. For example, as described elsewhere in this disclosure, where one or more guardians 545, 620 determine that the triggered alert may be better resolved by contacting the police, those guardians 545, 620 may then refer that triggered alert and data to one or more E911 systems 155 through platform 105. For example, after reviewing a triggered alert, a guardian 545, 620 may select E911 referral button 824. At this point, an E911 system 155 operator typically may receive the alert from system 105, along with associated geolocation 856, audiovideo stream 808, and/or the like, and the operator may then determine if officers should respond.

Additionally, in ‘receive resolve triggered alert to guardians and notify guardians’ step 980, as explained elsewhere in this disclosure, one or more guardians 545, 620 may receive and review a guardee 505 alert and determine it accidental, resolved, and/or otherwise handled. Thus, one or more guardians 545, 620 may then indicate that the alert is resolved, which is transmitted to system 105, which may then set the status 804 of the alert as resolved on platform 105.

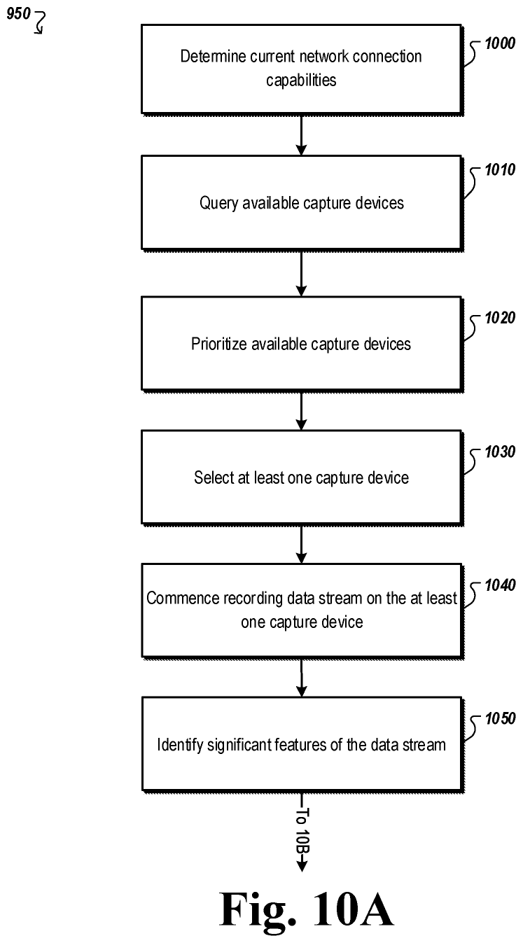

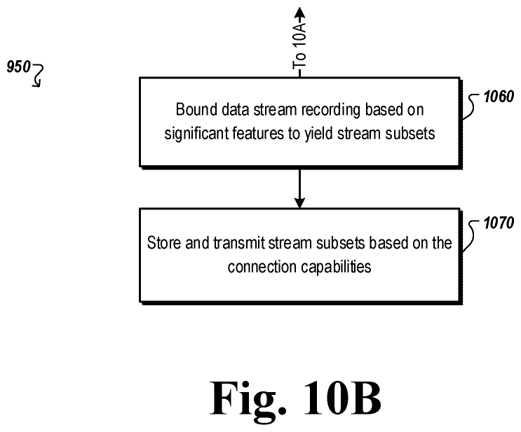

FIGS. 10A and 10B depict a process flow associated with the optimization step 950 on the platform 105. Step 950 may be further expanded to steps including ‘determine current network connection capabilities’ 1000; query available capture devices' 1010; ‘prioritize available capture devices’ 1020; ‘select at least one capture device’ 1030; ‘commence recording data stream on the at least one capture device’ 1040; ‘identify significant features of the data stream’ 1050; ‘bound data stream recording based on significant features to yield stream subsets’ 1060; ‘store and transmit stream subsets based on the connection capabilities’ 1070.

During ‘determine current network connection capabilities’ 1000 step, platform 105 typically may determine the current network capabilities of user device 120. For example, where device 120 is on a 4G LTE network with a large amount of available bandwidth, platform 105 may allow unrestricted data transmission quality and/or quantity. Conversely, where platform 105 determines that device 120 only has limited and/or infrequent data connection, platform 105 may restrict transmission quality and/or quantity accordingly. For example, as described elsewhere in this application, only certain optimized clips, clip frames, subsections of frames, and/or the like may be transmitted to attempt to best transmit identifying audio, video, and/or other characteristics given the likely available data resources. Learned profiles and elements typically may be stored on learning datastore 175.

Further, ‘query available capture devices’ 1010 step may query capture devices (e.g., microphone(s), video camera(s), GOPRO HERO; smart device 120, and/or the like). Typically, capture devices may be queried wirelessly for availability, capture abilities (e.g., quality, bitrate, refresh rate, light sensitivity of sensor, etc.), and/or the like. In some implementations, queries may be over one or more physical interfaces (e.g., USB, etc.). Device 120 and/or platform 105 typically may then populate one or more tables and/or datastores with the available capture devices and features for reference, use, and/or prioritization.

During ‘prioritize available capture devices’ 1020 step, platform 105 and/or user device 105 may preferentially arrange capture devices for use by platform 105 and/or user device 105. For example, a head-mounted external video camera may be given first priority, followed by smart device 120 rear camera, smart device 120 microphone, smart device 120 user camera, wearable 300, and/or the like. Platform 105 typically may determine such preferential order based on network capabilities, environmental qualities (e.g., fully lit, dusk, night, wooded area, and/or the like), capture device properties (e.g., image sensor sensitivity, audiovideo codecs available to device, etc.), and/or the like.

Additionally, ‘select at least one capture device’ 1030 step and ‘commence recording data stream on the at least one capture device’ 1040 step typically may be performed by platform 105 based on step 1020 prioritization of available capture devices. For example, given only a single available capture device, platform 105 may select only that device and operate that device at a bitrate sufficient to provide continuous streaming, five frames per second at medium resolution, two frames per second at high resolution, one frame per second at ultra resolution, and/or the like. In another implementation, several capture devices may be selected and platform 105 may operate one or more to provide such streaming or frame per resolution profiles. Thus, platform 105 may adaptively and optimally select for, and capture with, the most efficacious capture devices and settings to best capture the events leading to the emergency trigger.

For ‘identify significant features of the data stream’ 1050 step, as described elsewhere in this application, one or more features of one or more data streams from the capture devices may be analyzed and identified. For example, where specific features or known characteristics are visible (e.g., human face, scars, tattoos, clothing logos, etc.), those features may be identified as significant for capture and/or transmission, especially where low processing and/or transmission resources are available. These significant features typically may be tracked in the data stream and logged such that platform 105 may then preferentially bound and/or otherwise export such features in step 1060.

Further, for ‘bound data stream recording based on significant features to yield stream subsets’ 1060 step and ‘store and transmit stream subsets based on the connection capabilities’ 1070 step, platform 105 and/or device 120 typically may receive significant feature inputs from step 1050 and then bound, strip, and/or otherwise prioritized capture and/or transmission of such significant features during capture and transmission. In some implementations, one or more capture data streams may be prioritized and transmitted, while others may be stored on device 120 and/or associated storage permanently and/or temporarily until the prioritized transmissions are completed. In still further implementations, the full captured data stream may be stored for later review and/or transmission, while the prioritized significant feature subsets of the captured data stream(s) may be processed, stored, and transmitted first. Thus, again, platform 105 provides for both immediate and long-term improvements to capture and identification of perpetrators and circumstances surrounding emergency events to a far greater degree than in the current field.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may typically be integrated together in a single hardware and/or software product or packaged into multiple hardware and/or software products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for establishing an optimized and interconnected personal security platform over a computer network, comprising the steps of:
connecting to a user device and receiving user data;
receiving and querying saved guardian network data;
receiving, querying, and storing guardian sets from the user device;
querying and receiving at least one stream from at least one capture device to yield at least one capture data stream;
optimizing the at least one capture data stream for transmission to the personal security platform; and
upon receiving at least one trigger condition, sending an alert to the saved guardian sets.

2. The method of claim 1, further comprising the step of:
routing triggered alert to an E911 system.

3. The method of claim 1, further comprising the step of:
receiving and resolving triggered alert to guardians and notify guardians.

4. The method of claim 1, wherein the user device comprises a plurality of user devices.

5. The method of claim 1, wherein the optimizing step further comprises identifying significant features of the at least one capture data stream.

6. The method of claim 1, wherein the optimizing step further comprises bounding data stream recording based on significant features to yield stream subsets.

7. A method for optimizing an audiovisual stream for a personal security system, comprising the steps of:
determining current network connection capabilities;
querying available capture devices;
prioritizing available capture devices;
selecting at least one capture device;
commencing recording data stream on the at least one capture device;
identifying significant features of the data stream to yield at least one significant feature;
bounding data stream recording based on significant features to yield stream subsets; and
storing and transmitting the stream subsets based on the connection capabilities.

8. The method of claim 7, wherein the prioritizing step is performed based on the current network connection capabilities.

9. The method of claim 7, wherein the prioritizing step is performed based on the at least one capture device's field of view.

10. The method of claim 7, wherein the prioritizing step is performed based on ambient lighting conditions.

11. The method of claim 7, wherein the prioritizing step is performed based on the at least one significant features of the data stream.

12. A system for providing an optimized personal security platform over a computer network configured to operate over a network using a server and a plurality of end user devices, comprising:
a server operating the optimized personal security platform, the server adapted to communicate with a network; wherein the server is configured to:
connect to a user device and receive user data;
receive and query saved guardian network data;
receive, query, and store guardian sets from the user device;
query and receive at least one stream from at least one capture device to yield at least one capture data stream;
optimize the at least one capture data stream for transmission to the personal security platform; and
upon receipt at least one trigger condition, send an alert to the saved guardian sets.

13. The system of claim 12, wherein the optimize step further comprises identifying significant features of the at least one capture data stream.

14. The system of claim 12, wherein the optimize step further comprises bounding data stream recording based on significant features to yield stream subsets.

15. The system of claim 12, wherein the server is further configured to:
determine current network connection capabilities;
prioritize the at least one capture device to yield a prioritization; and
select the at least one capture device based on the prioritization.

16. The system of claim 12, wherein the server is further configured to:
identify significant features of the at least one capture data stream;
bound the at least one capture data stream recording based on the significant features to yield stream subsets; and
transmit the stream subsets based on the connection capabilities.

17. The system of claim 15, wherein the prioritizing step is performed based on the current network connection capabilities.

18. The system of claim 15, wherein the prioritizing step is performed based on the at least one capture device's field of view.

19. The system of claim 15, wherein the prioritizing step is performed based on ambient lighting conditions.

20. The system of claim 12, further wherein the user device is a wearable device, and wherein the wearable device further comprises:
a processor;
a display in electrical communication with the processor;
a capture module in electrical communication with the processor;
a data transfer module in electrical communication with the processor;
a health module in electrical communication with the processor;
a location module in electrical communication with the processor;
at least one notification module in electrical communication with the processor;
a power source in electrical communication with the processor; and
at least one attachment device operationally connected to the display.
